(19) United States
(12) Patent Application Publication
(10) Pub. No.: US 2018/0143490 A1
(43) Pub. Date: May 24, 2018

(54) MICROLENS ARRAY SUBSTRATE, MANUFACTURING METHOD OF THE SAME, ELECTROOPTICAL DEVICE, MANUFACTURING METHOD OF THE SAME, AND ELECTRONIC APPARATUS

(71) Applicant: SEIKO EPSON CORPORATION, Tokyo (JP)

(72) Inventor: Junichi WAKABAYASHI, Matsumoto-shi (JP)

(73) Assignee: SEIKO EPSON CORPORATION, Tokyo (JP)

(21) Appl. No.: 15/801,729

(22) Filed: Nov. 2, 2017

(30) Foreign Application Priority Data
Nov. 4, 2016 (JP) 2016-215973

(51) Int. Cl. G02F 1/1335; G03B 21/00; H04N 9/31; G02B 3/00

(52) U.S. Cl. CPC G02F 1/133526; G02B 3/0037; H04N 9/3197; G03B 21/006

(57) ABSTRACT

A microlens array substrate includes a substrate, a first microlens that is disposed on the substrate, and a second microlens that is disposed on the first microlens so as to be overlapped with the first microlens in a plan view, the second microlens is configured with a curved surface and includes a center portion and a peripheral portion that is disposed on the outer side of the center portion, and a curvature of the peripheral portion is larger than a curvature of the center portion.

### BACKGROUND

### 1. Technical Field

The present invention relates to a microlens array substrate, a manufacturing method of the same, an electrooptical device, a manufacturing method of the same, and an electronic apparatus.

### 2. Related Art

An electrooptical device including electrooptical substances, for example, liquid crystals between an element substrate and a counter substrate has been known. Examples of the electrooptical device include a liquid crystal device used as a liquid crystal light bulb of a projector, and an imaging device used as an imaging unit of a video camera. In the liquid crystal device, a light shielding portion is provided in a region where a switching element or wirings are disposed, and some incident light is shielded by the light shielding portion and is not used. Therefore, a configuration of including a microlens in at least one of the substrates in order to improve efficiency of utilization of light of the electrooptical device has been known (for example, see JP-A-2014-089230).

A microlens array substrate disclosed in JP-A-2014-089230 includes a first lens disposed on a side to which light is incident and a second lens which is disposed on a side from which light is emitted. The first lens is configured by filling a recess formed on a substrate with an inorganic material having a refractive index greater than that of the substrate. The second lens is formed of an inorganic material having a refractive index greater than that of the substrate to have a convex portion shape with a light transmitting layer (optical path length adjustment layer) interposed between the first lens and the second lens. A shape of the first lens and the second lens in a section view is a semi-elliptic shape.

In the microlens array substrate disclosed in JP-A-2014-089230, incident light is concentrated on a center side of the lens by the first lens and the light concentrated by the first lens is further concentrated by the second lens. By doing so, among light beams incident to a liquid crystal light bulb (electrooptical device) through a color filter substrate, light which is shielded by a light shielding layer disposed on a boundary between pixels is incident to an inner portion of an opening of the pixel, and thus, efficiency of utilization of light of the electrooptical device is improved.

A range of light concentrated by the first lens and emitted is large, when the light is close to the first lens, but the range thereof becomes small, as the light moves far away from the first lens. When a distance (optical path length) between the first lens and the second lens is small and the range of light concentrated by the first lens and incident to the second lens is larger than a range capable of light concentration on the inner portion of the opening of the pixel by the second lens, a quantity of light which is not concentrated on the inner portion of the opening of the pixel and not used, among the light beams incident to the second lens, is increased. In addition, when a quantity of light travelling to the outer side of the opening of the pixel is increased, the light is reflected by the light shielding layer, for example, and thus, stray light may be generated. Therefore, in the microlens array substrate disclosed in JP-A-2014-089230, the optical path length adjustment layer is provided between the first lens and the second lens so that the range of light concentrated by the first lens falls in the range capable of light concentration by the second lens.

However, when an arrangement pitch of pixels of an electrooptical device is minute, it is difficult to increase an aperture ratio of the pixels. Accordingly, as the arrangement pitch of pixels is minute, it is necessary that efficiency of utilization of light is increased. However, when a distance between the first lens and the second lens is large due to the optical path length adjustment layer as in the microlens array substrate disclosed in JP-A-2014-089230, light travelling from the first lens to the outer side may be emitted to an adjacent pixel side, before being incident to the second lens, and the light may become unused light. On the other hand, when the distance between the first lens and the second lens is small, the range of light concentrated by the first lens and emitted becomes larger than the range capable of light concentration by the second lens, and thus, a quantity of unused light may increase. Therefore, it is necessary to provide a microlens array substrate and an electrooptical device which are thinned by decreasing a distance between a first lens and a second lens and capable of improving efficiency of utilization of light.

### SUMMARY

The invention can be realized in the following aspects or application examples.

### APPLICATION EXAMPLE 1

According to this application example, there is provided a microlens array substrate including: a substrate; a first microlens that is disposed on the substrate; and a second microlens that is disposed on the first microlens so as to be overlapped with the first microlens in a plan view, in which the second microlens is configured with a curved surface and includes a center portion and a first peripheral portion that is disposed on the outer side of the center portion, and a curvature of the first peripheral portion is larger than a curvature of the center portion.

According to the configuration of the application example, light incident from a substrate side is concentrated by the first microlens, incident to the second microlens, further concentrated by the second microlens, and emitted to a side opposite to the substrate. Here, since the curvature of the first peripheral portion that is disposed on the outer side of the center portion of the second microlens is larger than the curvature of the center portion, light incident to the first peripheral portion of the second microlens is strongly curved, compared to light incident to the center portion (a refractive angle becomes great). Accordingly, compared to a case where the curvature of the first peripheral portion and the curvature of the center portion are the same as each other, a larger quantity of light among light beams incident to the outer side of the center portion of the second microlens can be concentrated on the center portion side. That is, compared to a case where the curvature of the first peripheral portion and the curvature of the center portion are the same as each other, it is possible to widen a range capable of light concentration by the second microlens with respect to the light incident from the first microlens. Accordingly, it is possible to decrease a distance between the first microlens and the second microlens without decreasing a quantity of light concentrated by the second microlens, and therefore, an optical path length adjustment layer is not necessary. By decreasing the distance between the first microlens and the second microlens, it is possible to allow light travelling from the first microlens to the outer side to be incident to the second microlens and use the light. Therefore, it is possible to provide a microlens array substrate which is thinned by decreasing the distance between the first microlens and the second microlens and capable of improving efficiency of utilization of light.

### APPLICATION EXAMPLE 2

In the microlens array substrate according to the application example, it is preferable that the second microlens include a second peripheral portion that is disposed on the outer side of the first peripheral portion, and a curvature of the second peripheral portion be equal to or smaller than the curvature of the center portion.

According to the configuration of the application example, the second microlens includes the second peripheral portion having a curvature equal to that of the center portion or smaller than that of the center portion, on the outer side of the first peripheral portion. Accordingly, compared to a case where the second peripheral portion is not provided, it is possible to further increase the curvature of the first peripheral portion positioned between the center portion and the second peripheral portion. Therefore, it is possible to widen the range capable of light concentration by the second microlens with respect to the light incident from the first microlens.

### APPLICATION EXAMPLE 3

In the microlens array substrate according to the application example, it is preferable that the first microlens be formed of a material having a refractive index greater than a refractive index of the substrate so as to fill a recess provided on the substrate, and the second microlens be formed of a material having a refractive index greater than the refractive index of the substrate so as to have a convex portion shape projected to a side opposite to the first microlens.

According to the configuration of the application example, the first microlens having a convex portion shape projected to the substrate side, and the second microlens having a convex portion shape projected to a side opposite to the first microlens are formed of a material having a refractive index greater than the refractive index of the substrate. Accordingly, in a case where light is incident from the substrate side, the second microlens has a convex portion shape projected to a side where light is emitted. Thus, compared to a case of a convex portion shape projected to a side where light is incident, light which travels from the first microlens side to the outer side and is incident to the first peripheral portion of the second microlens can be strongly curved to the inner side. Therefore, it is possible to further improve efficiency of utilization of light.

### APPLICATION EXAMPLE 4

In the microlens array substrate according to the application example, it is preferable that a cross section shape of the second microlens be approximately symmetrical with respect to an apex of the center portion.

According to the configuration of the application example, since the cross section shape of the second microlens is approximately symmetrical with respect to the apex of the center portion, light beams incident to positions symmetrical with respect to the apex of the center portion in the same direction among light beams incident to the second microlens are refracted at approximately the same angle. Accordingly, a variation in angle of light emitted from the second microlens is reduced. Therefore, it is possible to provide a microlens array substrate capable of setting brightness of openings of pixels to be more uniform, in a case of being applied to an electrooptical device, for example.

### APPLICATION EXAMPLE 5

According to this application example, there is provided an electrooptical device including: a first substrate including a switching element that is provided for each pixel, and a light shielding portion that includes an opening for each pixel and provided so as to be overlapped with the switching element in a plan view; a second substrate that includes the microlens array substrate according to the application example and is disposed so as to face the first substrate; and an electrooptical layer that is disposed between the first substrate and the second substrate, in which the first microlens and the second microlens are disposed so as to be overlapped with the opening for each pixel in a plan view.

According to the configuration of the application example, the electrooptical device includes a microlens array substrate which is thinned by decreasing a distance between a first microlens and a second microlens and capable of improving efficiency of utilization of light. Therefore, it is possible to provide a thin electrooptical device in which an image displayed by the driving of the switching element is bright, although an arrangement pitch of pixels is minute.

### APPLICATON EXAMPLE 6

According to this application example, there is provided an electrooptical device including: a first substrate that includes a light receiving element that is provided for each pixel, and a light shielding portion that includes an opening for each pixel; and a second substrate that includes the microlens array substrate according to the application example and is disposed so as to face the first substrate, in which the first microlens, the second microlens, and the light receiving element are disposed so as to be overlapped with the opening for each pixel in a plan view.

According to the configuration of the application example, the electrooptical device includes a microlens array substrate which is thinned by decreasing a distance between a first microlens and a second microlens and capable of improving efficiency of utilization of light. Therefore, it is possible to provide a thin electrooptical device in which an image obtained by the light receiving element is bright, although an arrangement pitch of pixels is minute.

### APPLICATION EXAMPLE 7

According to this application example, there is provided an electronic apparatus including: the electrooptical device according to the application example.

According to the configuration of the application example, it is possible to provide an electronic apparatus capable of displaying and obtaining a bright image having excellent quality.

### APPLICATION EXAMPLE 8

According to this application example, there is provided a manufacturing method of a microlens array substrate including: forming a recess on a surface of a substrate; forming a first lens layer with a material having a refractive index greater than a refractive index of the substrate so as to fill the recess of the substrate; and forming a second lens layer having a convex portion configured with a curved surface disposed so as to be overlapped with the recess in a plan view, on the first lens layer with a material having a refractive index greater than the refractive index of the substrate, in which the convex portion includes a center portion and a first peripheral portion that is disposed on the outer side of the center portion, and a curvature of the first peripheral portion is greater than a curvature of the center portion.

According to the manufacturing method of the application example, the first microlens having a convex portion shape projected to the substrate side and the second microlens having a convex portion shape projected to a side opposite to the first microlens can be formed on the substrate. Since the curvature of the first peripheral portion that is disposed on the outer side of the center portion of the second microlens is greater than the curvature of the center portion, light incident to the first peripheral portion of the second microlens is strongly curved than light incident to the center portion. Accordingly, compared to a case where the curvature of the first peripheral portion and the curvature of the center portion are the same as each other, a larger quantity of light among light beams incident to the outer side of the center portion of the second microlens can be concentrated on the center portion side. That is, compared to a case where the curvature of the first peripheral portion and the curvature of the center portion are the same as each other, it is possible to widen a range capable of light concentration by the second microlens with respect to the light incident from the first microlens. Accordingly, it is possible to decrease a distance between the first microlens and the second microlens without decreasing a quantity of light concentrated by the second microlens, and therefore, an optical path length adjustment layer is not necessary. By decreasing the distance between the first microlens and the second microlens, it is possible to allow oblique light travelling from the first microlens to the outer side to be incident to the second microlens and use the light. Therefore, it is possible to manufacture a microlens array substrate which is thinned by decreasing the distance between the first microlens and the second microlens and capable of improving efficiency of utilization of light.

### APPLICATION EXAMPLE 9

According to this application example, there is provided a manufacturing method of an electrooptical device including: the manufacturing method of a microlens array substrate according to the application example.

According to the manufacturing method of the application example, it is possible to manufacture an electrooptical device including a microlens array substrate which is thinned by decreasing the distance between the first microlens and the second microlens and capable of improving efficiency of utilization of light.

### BRIEF DESCRIPTION OF THE DRAWINGS

The invention will be described with reference to the accompanying drawings, wherein like numbers reference like elements.

FIG. 1 is a schematic plan view showing a configuration of a liquid crystal device according to a first embodiment.

FIG. 2 is an equivalent circuit diagram showing an electrical configuration of a liquid crystal device according to the first embodiment.

FIG. 3 is a schematic sectional view showing a configuration of the liquid crystal device according to the first embodiment.

FIG. 4 is a schematic sectional view showing a cross section shape of a second microlens according to the first embodiment.

FIG. 5 is a schematic sectional view showing enlarged main parts of two pixels of FIG. 3.

FIG. 6 is a schematic sectional view showing a manufacturing method of the microlens array substrate according to the first embodiment.

FIG. 7 is a schematic sectional view showing the manufacturing method of the microlens array substrate according to the first embodiment.

FIG. 8 is a schematic sectional view showing the manufacturing method of the microlens array substrate according to the first embodiment.

FIG. 9 is a schematic sectional view showing the manufacturing method of the microlens array substrate according to the first embodiment.

FIG. 10 is a schematic sectional view showing the manufacturing method of the microlens array substrate according to the first embodiment.

FIG. 11 is a schematic sectional view showing the manufacturing method of the microlens array substrate according to the first embodiment.

FIG. 12 is a schematic sectional view showing the manufacturing method of the microlens array substrate according to the first embodiment.

FIG. 13 is a schematic sectional view showing the manufacturing method of the microlens array substrate according to the first embodiment.

FIG. 14 is a schematic sectional view showing the manufacturing method of the microlens array substrate according to the first embodiment.

FIG. 15 is a schematic sectional view showing the manufacturing method of the microlens array substrate according to the first embodiment.

FIG. 16 is a schematic view showing a configuration of a projector as an electronic apparatus according to the first embodiment.

FIG. 17 is a schematic sectional view showing a manufacturing method of a microlens array substrate according to a second embodiment.

FIG. 18 is a schematic sectional view showing the manufacturing method of the microlens array substrate according to the second embodiment.

FIG. 19 is a schematic sectional view showing the manufacturing method of the microlens array substrate according to the second embodiment.

FIG. 20 is a schematic sectional view showing the manufacturing method of the microlens array substrate according to the second embodiment.

FIG. 21 is a schematic sectional view showing the manufacturing method of the microlens array substrate according to the second embodiment.

FIG. 22 is a schematic sectional view showing a manufacturing method of a microlens array substrate according to a third embodiment.

FIG. 23 is a schematic sectional view showing the manufacturing method of the microlens array substrate according to the third embodiment.

FIG. 24 is a schematic sectional view showing the manufacturing method of the microlens array substrate according to the third embodiment.

FIG. 25 is a schematic sectional view showing the manufacturing method of the microlens array substrate according to the third embodiment.

FIG. 26 is a schematic sectional view showing the manufacturing method of the microlens array substrate according to the third embodiment.

FIG. 27 is a schematic sectional view showing a configuration of an imaging device according to a fourth embodiment.

FIG. 28 is a schematic view showing a configuration of a video camera as an electronic apparatus according to the fourth embodiment.

### DESCRIPTION OF EXEMPLARY EMBODIMENTS

Hereinafter, embodiments of the invention will be described with reference to the drawings. The drawings used here are displayed to be appropriately enlarged or contracted so that the described part is recognizable. Parts other than constituent elements necessary for the description may be omitted.

In the following aspects, the expression “on a substrate”, for example, indicates a case where a component is disposed to be in contact with the upper portion of the substrate, a case where a component is disposed on the substrate with another component interposed therebetween, or a case where a part of a component is disposed to be in contact with the upper portion of the substrate and another part of the component is disposed on the substrate with another component interposed therebetween.

### First Embodiment

### Electrooptical Device

In a first embodiment, an active matrix type liquid crystal device including a thin film transistor (TFT) as a switching element of a pixel will be described as an example of an electrooptical device. This liquid crystal device, for example, can be suitably used as an optical modulation element (liquid crystal light bulb) of a convex portion type display apparatus (projector) which will be described later.

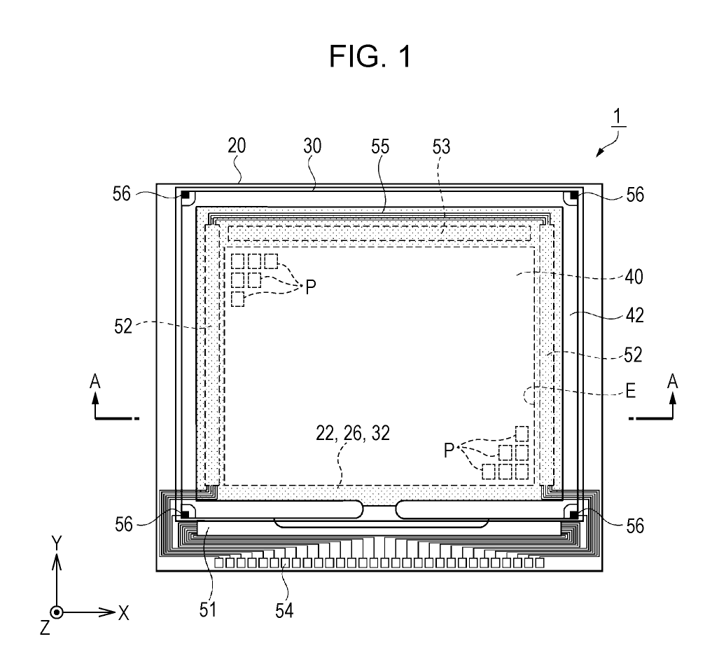

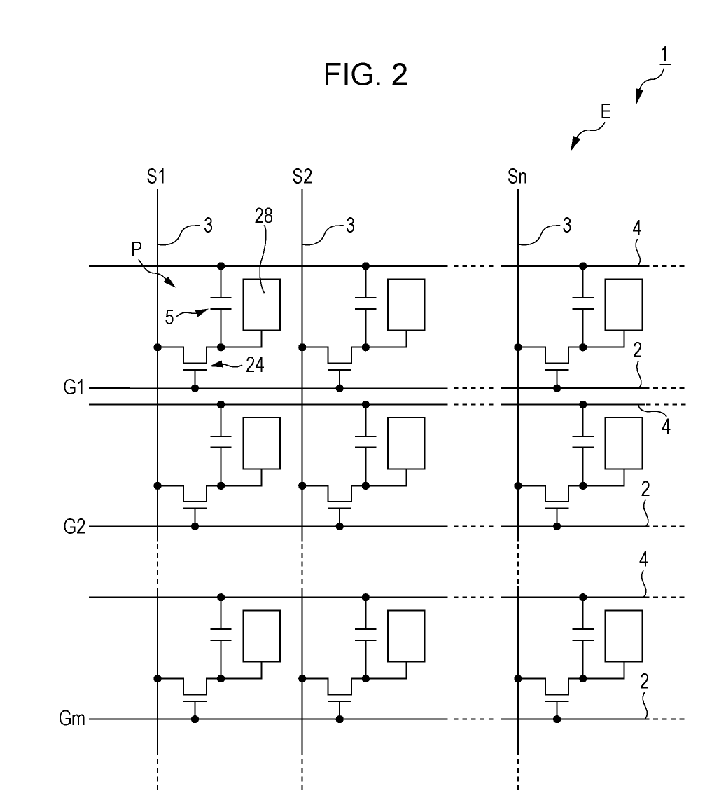

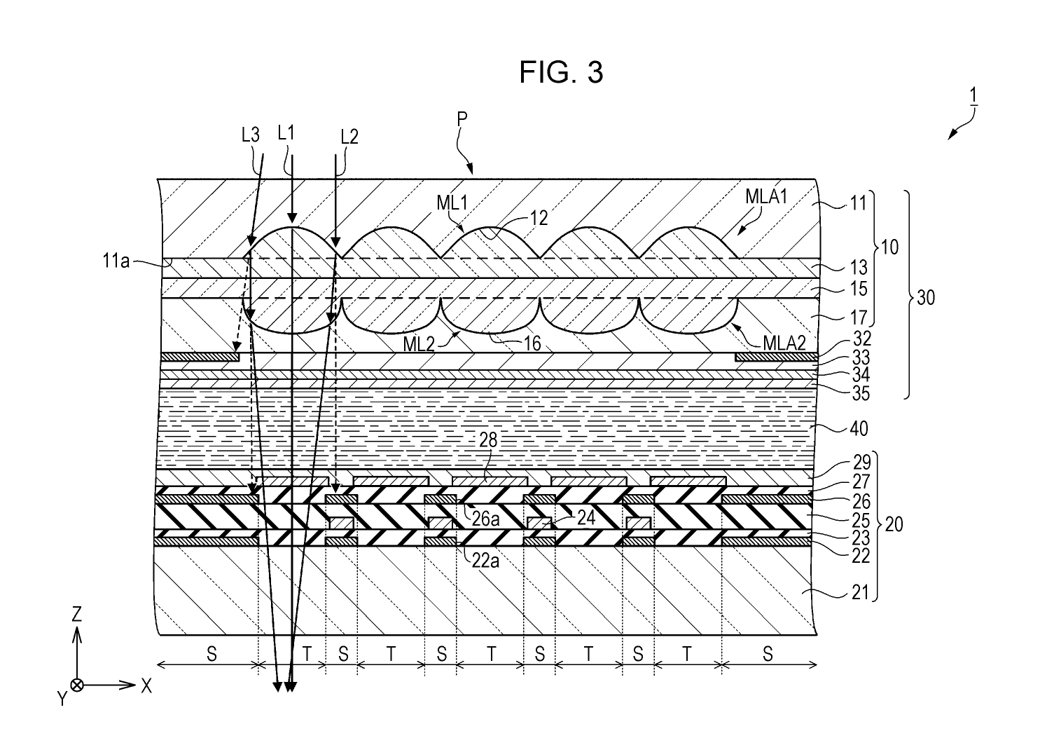

First, the liquid crystal device as the electrooptical device according to the first embodiment will be described with reference to FIGS. 1 to 3. FIG. 1 is a schematic plan view showing a configuration of the liquid crystal device according to the first embodiment. FIG. 2 is an equivalent circuit diagram showing an electrical configuration of the liquid crystal device according to the first embodiment. FIG. 3 is a schematic sectional view showing a configuration of the liquid crystal device according to the first embodiment. Specifically, FIG. 3 is a schematic sectional view taken along line A-A of FIG. 1.

As shown in FIG. 1 and FIG. 3, a liquid crystal device 1 according to the embodiment includes an element substrate 20 as a first substrate, a counter substrate 30 as a second substrate which is disposed to face the element substrate 20, a sealing material 42, and a liquid crystal layer 40 as an electrooptical layer. As shown in FIG. 1, the size of the element substrate 20 is larger than that of the counter substrate 30, and both substrates are bonded to each other through the sealing material 42 which is disposed in a frame shape along the edge of the counter substrate 30.

The liquid crystal layer 40 is sealed in a space surrounded by the element substrate 20, the counter substrate 30, and the sealing material 42, and is configured with liquid crystals having positive or negative dielectric anisotropy. The sealing material 42 is, for example, formed of an adhesive such as a thermosetting or ultraviolet curable epoxy resin. A spacer (not shown) for holding a constant space between the element substrate 20 and the counter substrate 30 is added to the sealing material 42.

Light shielding layers 22 and 26 provided on the element substrate 20 and a light shielding layer 32 provided on the counter substrate 30 are disposed on the inner side of the sealing material 42 disposed in a frame shape. The light shielding layers 22, 26, and 32 have frame-shaped periphery portions and are, for example, formed of a metal or a metal oxide having light shielding properties. The inner side of the frame-shaped light shielding layers 22, 26, and 32 is a display region E in which a plurality of pixels P are arranged. The pixel P has an approximately polygonal planar shape. The pixel P, for example, has an approximately rectangular shape and the pixels are arranged in a matrix shape.

The display region E is a region substantially contributing to the display in the liquid crystal device 1. The light shielding layers 22 and 26 provided on the element substrate 20 are, for example, provided in the display region E in a lattice shape so as to partition opening regions of the plurality of pixels P in a plan view. The liquid crystal device 1 may include a dummy region which is provided so as to surround the display region E and does not substantially contribute to the display.

A data line driving circuit 51 and a plurality of external connection terminals 54 are provided along a first side, on a side opposite to the display region E of the sealing material 42 formed along the first side of the element substrate 20. In addition, an inspection circuit 53 is provided on a side of the display region E of the sealing material 42 along a second side facing the first side. Further, scanning line driving circuits 52 are provided on the inner side of the sealing material 42 along other two sides which are orthogonal to the first and second sides and face each other.

A plurality of wirings 55 connecting the two scanning line driving circuits 52 to each other are provided on the display region E side of the sealing material 42 on the second side where the inspection circuit 53 is provided. Wirings connecting the data line driving circuit 51 and the scanning line driving circuits 52 are connected to the plurality of external connection terminals 54. Upper and lower electrical connection units 56 for realizing electric connection between the element substrate 20 and the counter substrate 30 are provided on the corners of the counter substrate 30. The disposition of the inspection circuit 53 are not limited thereto and may be provided at a position along the inner side of the sealing material 42 between the data line driving circuit 51 and the display region E.

In the following description, a direction along the first side on which the data line driving circuit 51 is provided is set as an X direction, and a direction along the other two sides which are orthogonal to the first side and face to each other is set as a Y direction. The X direction is a direction along line A-A of FIG. 1. The light shielding layers 22 and 26 are provided in a lattice shape along the X direction and the Y direction. The opening regions of the pixels P are partitioned by the light shielding layers 22 and 26 in a lattice shape and arranged in a matrix shape along the X direction and the Y direction.

A direction which is orthogonal to the X direction and the Y direction and facing the front of FIG. 1 is set as a Z direction. In this specification, a view in a normal direction (Z direction) of the counter substrate 30 side surface of the liquid crystal device 1 is called a “plan view”.

As shown in FIG. 2, in the display region E, scanning lines 2 and data lines 3 are formed to intersect with each other, and a pixel P is provided according to the intersection of the scanning line 2 and the data line 3. A pixel electrode 28 and a TFT 24 as a switching element are provided in each of pixels P.

A source electrode (not shown) of the TFT 24 is electrically connected to the data line 3 extended from the data line driving circuit 51. Image signals (data signals) S1, S2, . . . , Sn are supplied to the data line 3 from the data line driving circuit 51 (see FIG. 1) in a line sequential manner. A gate electrode (not shown) of the TFT 24 is a part of the scanning line 2 extended from the scanning line driving circuit 52. Scanning signals G1, G2, . . . , Gm are supplied to the scanning line 2 from the scanning line driving circuit 52 in a line sequential manner. A drain electrode (not shown) of the TFT 24 is electrically connected to the pixel electrode 28.

By turning the state of the TFT 24 to an on state for a certain period of time, the image signals S1, S2, . . . , Sn are written in the pixel electrode 28 through the data line 3 at a predetermined timing. The image signals at a predetermined level written in the liquid crystal layer 40 through the pixel electrode 28 as described above are held at a liquid crystal capacitance formed between the liquid crystal layer and a common electrode 34 (see FIG. 3) provided on the counter substrate 30 for a certain period of time.

In order to prevent leakage of the held image signals S1, S2, . . . , Sn, a storage capacitance 5 is formed between a capacitance line 4 formed along the scanning line 2 and the pixel electrode 28 and is arranged in parallel to the liquid crystal capacitance. As described above, when a voltage signal is applied to the liquid crystals of each pixel P, an orientation state of the liquid crystals is changed in accordance with the applied voltage level. Therefore, light incident to the liquid crystal layer 40 (see FIG. 3) is modulated and gradation display can be performed.

Regarding the liquid crystals configuring the liquid crystal layer 40, the orientation and the order of molecular association in accordance with the applied voltage level, and thus, light is modulated and gradation display can be performed. For example, in a case of a normally white mode, transmittance with respect to incident light decreases in accordance with the applied voltage in a unit of each pixel P. In a normally black mode, transmittance with respect to incident light increases in accordance with the applied voltage in a unit of each pixel P, and light having contrast according to the image signal is entirely emitted from the liquid crystal device 1.

As shown in FIG. 3, the counter substrate 30 according to the first embodiment includes a microlens array substrate 10, a light shielding layer 32, a protective layer 33, a common electrode 34, and an orientation film 35. The microlens array substrate 10 according to the first embodiment includes a two-stage microlens of a microlens ML1 as a first microlens and a microlens ML2 as a second microlens.

The microlens array substrate 10 includes a substrate 11, a lens layer 13 as a first lens layer, a lens layer 15 as a second lens layer, and a flattening layer 17. The substrate 11 is, for example, formed of an inorganic material having light transmittance such as glass or quartz. A surface of the substrate 11 on the liquid crystal layer 40 side is set as a surface 11a. The substrate 11 includes a plurality of recesses 12 formed on the surface 11a. Each recess 12 is provided for each pixel P. Regarding a cross section shape of the recess 12, for example, a center portion thereof is a curved surface and a peripheral portion surrounding the center portion is an inclined surface (so-called tapered surface). The entire recess 12 may be configured with a curved surface.

The lens layer 13 is formed to be thicker than a depth of the recess 12 so as to fill the recess 12 and cover the surface 11a of the substrate 11. The lens layer 13 is formed of a material having light transmittance and having a refractive index different from that of the substrate 11. In the embodiment, the lens layer 13 is formed of an inorganic material having a refractive index greater than that of the substrate 11. Examples of such an inorganic material include SiON and Al₂O₃.

The microlens ML1 having a convex portion shape projected to the substrate 11 side is configured by filling the recess 12 with the material forming the lens layer 13. That is, a part of the lens layer 13 filling the recess 12 is the microlens ML1. Each microlens ML1 is provided to correspond to the pixel P. In addition, a microlens array MLA1 is configured with the plurality of microlenses ML1. The surface of the lens layer 13 is a flat surface which is approximately parallel to the surface 11a of the substrate 11.

Incident light incident to the center portion of the microlens ML1 is concentrated towards the center (focal point of curved surface) of the microlens ML1. In addition, incident light beams incident to the peripheral portion (inclined surface) of the microlens ML1 are refracted to the center side of the microlens ML1 at approximately the same angle, if incident angles are approximately the same as each other. Accordingly, compared to a case where the entire microlens ML1 is configured with a curved surface, the excessive refraction of incident light is prevented and a variation in angles of light beams incident to the liquid crystal layers 40 is prevented.

The lens layer 15 is formed on the lens layer 13. The lens layer 15, for example, has a refractive index which is approximately the same as that of the lens layer 13 and is formed of the same material as that of the lens layer 13. The lens layer 15 includes a plurality of convex portions 16 projected to the liquid crystal layer 40 side (side opposite to the microlenses ML1). The convex portions 16 in the lens layer 15 are microlenses ML2. Hereinafter, a surface of the convex portion 16 (surface in contact with the flattening layer 17) is called a lens surface.

Each convex portion 16 is provided to correspond to the pixel P and is disposed so as to be overlapped with each recess 12 in a plan view. Accordingly, the microlens ML2 is disposed so as to be overlapped with the microlens ML1 in a plan view. A cross section shape of the convex portion 16 is configured with a curved surface. Details of the cross section shape of the convex portion 16 will be described later.

The flattening layer 17 is formed to be thicker than a height of the convex portion 16 so as to fill spaces between the convex portions 16 and surrounding of the convex portions 16 and cover the lens layer 15. The flattening layer 17 is formed of an inorganic material having light transmittance and, for example, having a refractive index lower than that of the lens layer 15. As such an inorganic material, SiO₂ is used, for example. The microlens ML2 having a convex portion shape as the second microlens is configured by covering the convex portions 16 with the flattening layer 17. Each microlens ML2 is provided to correspond to the pixel P. In addition, a microlens array MLA2 is configured with the plurality of microlenses ML2.

The flattening layer 17 has a function of setting a distance between the microlens ML2 and the light shielding layer 26 to be a desired value. Accordingly, a layer thickness of the flattening layer 17 is suitably set based on optical conditions such as a focal length of the microlens ML2 according to a wavelength of light. A surface of the flattening layer 17 is approximately a flat surface.

The light shielding layer 32 is provided on the microlens array substrate 10 (flattening layer 17). The light shielding layer 32 is provided so as to surround the surrounding of the display region E (see FIG. 1) where the microlens ML1 and microlens ML2 are disposed. The light shielding layer 32 is, for example, formed of a metal or a metal compound. The light shielding layer 32 may be provided in the display region E so as to be overlapped with the light shielding layer 22 and the light shielding layer 26 of the element substrate 20 in a plan view. In this case, the light shielding layer 32 may be formed in a lattice shape, an island shape, or a stripe shape, and is preferably disposed in a range narrower than that of the light shielding layer 22 and the light shielding layer 26 in a plan view.

The protective layer 33 is provided so as to cover the microlens array substrate 10 (flattening layer 17) and the light shielding layer 32. The common electrode 34 is provided so as to cover the protective layer 33. The common electrode 34 is formed over the plurality of pixels P. The common electrode 34 is, for example, formed of a transparent conductive film such as indium tin oxide (ITO) or indium zinc oxide (IZO). The protective layer 33 covers the light shielding layer 32 so that the surface of the common electrode 34 on the liquid crystal layer 40 side is flattened, but the common electrode 34 may be formed so as to directly cover the conductive light shielding layer 32 without providing the protective layer 33. The orientation film 35 is provided so as to cover the common electrode 34.

The element substrate 20 includes a substrate 21, a light shielding layer 22, an insulating layer 23, a TFT 24, an insulating layer 25, a light shielding layer 26, an insulating layer 27, a pixel electrode 28, and an orientation film 29. The substrate 21 is, for example, formed of a material having light transmittance such as glass or quartz.

The light shielding layer 22 is provided on the substrate 21. The light shielding layer 22 is formed in a lattice shape so as to be overlapped on the light shielding layer 26 which is the upper layer in a plan view. The light shielding layer 22 and the light shielding layer 26 are, for example, formed of a metal or a metal compound. The light shielding layer 22 and the light shielding layer 26 are disposed so as to interpose the TFT 24 in a thickness direction (Z direction) of the element substrate 20. The light shielding layer 22 is overlapped with at least a channel region of the TFT 24 in a plan view.

By providing the light shielding layer 22 and the light shielding layer 26, incidence of light to the TFT 24 is prevented, and thus, an increase in optical leak current or malfunction due to light in the TFT 24 can be prevented. A light shielding portion S is configured with the light shielding layer 22 and the light shielding layer 26. A region (inside of an opening 22a) surrounded by the light shielding layer 22 and a region (inside of an opening 26a) surrounded by the light shielding layer 26 are overlapped with each other in a plan view and become openings T of the region of the pixel P through which light is transmitted.

The insulating layer 23 is provided so as to cover the substrate 21 and the light shielding layer 22. The insulating layer 23 is, for example, formed of an inorganic material such as SiO₂.

The TFT 24 is provided on the insulating layer 23 and is disposed in a region overlapped with the light shielding layer 22 and the light shielding layer 26 in a plan view. The TFT 24 is a switching element driving the pixel electrode 28. The TFT 24 is configured with a semiconductor layer, a gate electrode, a source electrode, and a drain electrode (not shown). In the semiconductor layer, a source region, a channel region, and a drain region are formed. A lightly doped drain (LDD) region may be formed on an interface between the channel region and the source region or between the channel region and the drain region.

The gate electrode is formed in a region overlapped with the channel region of the semiconductor layer in a plan view in the element substrate 20 through a part of the insulating layer 25 (gate insulating film). Although not shown, the gate electrode is electrically connected to the scanning line disposed on a lower layer side through a contact hole and controls the on/off state of the TFT 24 by applying scanning signals.

The insulating layer 25 is provided so as to cover the insulating layer 23 and the TFT 24. The insulating layer 25 is, for example, formed of an inorganic material such as SiO₂. The insulating layer 25 includes a gate insulating film which insulates the semiconductor layer and the gate electrode of TFT 24 from each other. Unevenness of the surface generated due to the TFT 24 is alleviated by the insulating layer 25. The light shielding layer 26 is provided on the insulating layer 25. The insulating layer 27 formed of an inorganic material is provided so as to cover the insulating layer 25 and the light shielding layer 26.

The pixel electrode 28 is provided on the insulating layer 27 so as to correspond to the pixel P. The pixel electrode 28 is disposed in a region overlapped with the opening 22a of the light shielding layer 22 and the opening 26a of the light shielding layer 26 in a plan view. The pixel electrode 28 is, for example, formed of a transparent conductive film such as indium tin oxide (ITO) or indium zinc oxide (IZO). The orientation film 29 is provided so as to cover the pixel electrode 28. The liquid crystal layer 40 is sealed between the orientation film 29 on the element substrate 20 side and the orientation film 35 on the counter substrate 30 side.

Although not shown, in the region overlapped with the light shielding layer 22 and the light shielding layer 26 in a plan view, electrodes, wirings, and relay electrodes for supply an electric signal to the TFT 24 or capacitance electrodes configuring the storage capacitance 5 (see FIG. 2) are provided. The light shielding layer 22 or the light shielding layer 26 may have a configuration of including such electrodes, wirings, relay electrodes, and capacitance electrodes.

In the liquid crystal device 1 according to the first embodiment, light generated from a light source is, for example, incident from the side of the counter substrate (substrate 11) including the microlenses ML1 and ML2. Among the incident light beams, light L1 incident to the center of the microlens ML1 which is in the first stage along the normal direction of the surface of the counter substrate 30 (substrate 11) travels straight, is incident to the center of the microlens ML2 which is in the second stage, then travels straight, transmitted through the inner portion of the opening T of the pixel P, and is emitted to the element substrate 20 side.

Hereinafter, the normal direction of the surface of the counter substrate 30 (substrate 11) is simply referred to as a “normal direction”. The “normal direction” is a direction along the Z direction of FIG. 3 and is approximately the same direction as the normal direction of the element substrate 20 (substrate 21).

In a case where light L2 incident to an end portion of the microlens ML1 along the normal direction travels straight, the light L2 may be shielded by the light shielding layer 26 as shown with a broken line, but the light L2 is refracted to the center side of the microlens ML1 and incident to the microlens ML2 due to a difference in refractive indexes between the substrate 11 and the lens layer 13 (positive refractive power). The light L2 incident to the microlens ML2 is further refracted to the center side of the microlens ML2 due to a difference in refractive indexes between the lens layer 15 and the flattening layer (positive refractive power), and the light L2 is transmitted through the opening T of the pixel P and emitted to the element substrate 20 side.

In a case where light L3 which is incident to the end portion of the microlens ML1 obliquely with respect to the normal direction and towards the outer side with respect to the center of the microlens ML1 travels straight, the light L3 may be shielded by the light shielding layer 32 as shown with a broken line, but the light L3 is refracted to the center side of the microlens ML1 and incident to the microlens ML2 due to a difference in refractive indexes between the substrate 11 and the lens layer 13. In a case where the light L3 incident to the microlens ML2 travels straight, the light L3 may be shielded by the light shielding layer 26 as shown with a broken line, but the light L3 is further refracted to the center side of the microlens ML2 due to a difference in refractive indexes between the lens layer 15 and the flattening layer 17, and the light L3 is transmitted through the opening T of the pixel P and emitted to the element substrate 20 side.

As described above, in the liquid crystal device 1, the light beams L2 and L3 shielded by the light shielding layer 32 and the light shielding layer 26 in a case where the light beams travel straight, can be refracted to the center side of the opening T of the pixel P and transmitted through the inner portion of the opening T, due to the operation of the microlenses ML1 and ML2 having two stages. As a result, it is possible to increase a quantity of light emitted from the element substrate 20 side, and therefore, it is possible to increase efficiency of utilization of light.

### Cross Section Shape of Second Microlens

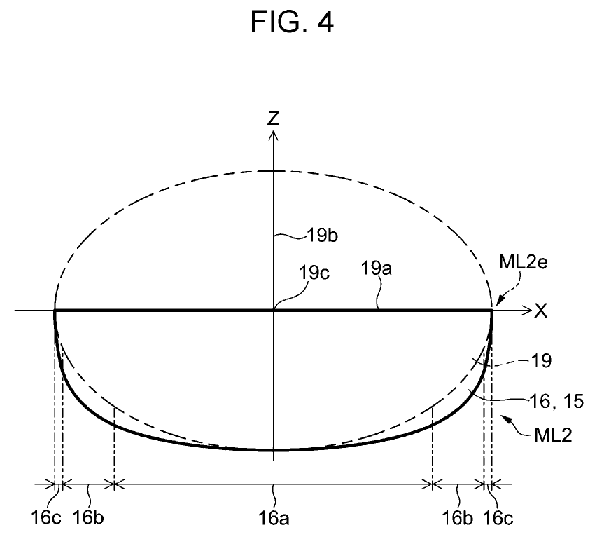

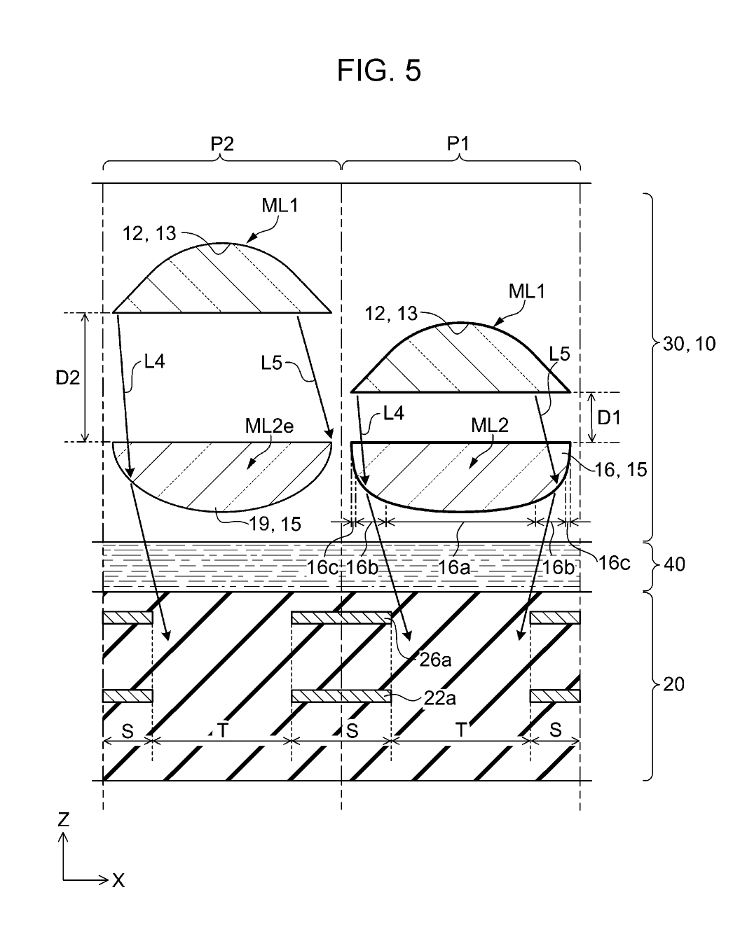

Next, a cross section shape and an effect of the second microlens (microlens ML2) according to the first embodiment will be described with reference to FIGS. 4 and 5. FIG. 4 is a schematic sectional view showing a cross section shape of the second microlens according to the first embodiment. Specifically, FIG. 4 is a partially enlarged view of the microlens ML2 (convex portion 16) of FIG. 3. FIG. 5 is a schematic sectional view showing enlarged main parts of two pixels of FIG. 3.

As shown with solid lines in FIG. 4, a lens surface of the microlens ML2 (convex portion 16) according to the first embodiment includes a center portion 16a, a peripheral portion 16b as a first peripheral portion disposed on the outer side of the center portion 16a, and a peripheral portion 16c as a second peripheral portion positioned on the outer side of the peripheral portion 16b. A curvature of the peripheral portion 16b is greater than a curvature of the center portion 16a. A curvature of the peripheral portion 16c is equal to or smaller than the curvature of the center portion 16a (same as the curvature of the center portion 16a and smaller than the curvature of the center portion 16a).

FIG. 4 shows an ellipse 19 with a two-dot chain line as a comparison of the cross section shape of the convex portion 16. For example, as a microlens array substrate disclosed in JP-A-2014-089230, the cross section shape of the second microlens included in the microlens array substrate of the related art is a semi-ellipse, in many cases. Accordingly, FIG. 4 is a view showing the cross section shape of the microlens ML2 (convex portion 16) according to the first embodiment in comparison to the cross section shape of the second microlens (microlens ML2e). In FIG. 4, an X axis is an axis passing through a center 19c of the ellipse 19 along the X direction and Z axis is an axis passing through the center 19c of the ellipse 19 along the Z direction.

A length of a long axis (long diameter) 19a of the ellipse 19 shown in FIG. 4 is the same as a diameter (length in the X axis direction) of the convex portion 16, and a length of ½ of a short axis (short diameter) 19b of the ellipse 19 is the same as the height (length in the Z axis direction) of the convex portion 16. Accordingly, the cross section shape of the microlens ML2 (convex portion 16) according to the embodiment is substantially overlapped with the half of the ellipse 19 on the lower side (negative Z direction side) which is the cross section shape of the microlens ML2e of the related art. However, the lens surface of the microlens ML2 (convex portion 16) is a shape close to a trapezoid in which the peripheral portion 16b is protruded to the outer side than the lens surface of the microlens ML2e (ellipse 19) of the related art.

Each portion of the lens surface of the microlens ML2 (convex portion 16) is compared with each portion of the lens surface of the microlens ML2e (ellipse 19) of the related art. A curvature of the peripheral portion 16b of the microlens ML2 is greater than a curvature of the portion corresponding to the peripheral portion 16b of the ellipse 19. Accordingly, an angle formed by the lens surface and the surface 11a of the substrate 11 in the peripheral portion 16b of the microlens ML2 is greater than that in the microlens ML2e of the related art.

Thus, an angle of incidence of light incident to the peripheral portion 16b of the microlens ML2 with respect to the lens surface along the normal direction (Z axis direction) from the positive Z direction side is larger than an angle of incidence of light incident to this portion of the microlens ML2e of the related art. Accordingly, a refractive angle of light emitted from the peripheral portion 16b of the microlens ML2 is larger than that of the microlens ML2e of the related art, and therefore, a quantity of light travelling from the peripheral portion 16b of the microlens ML2 to the center side of the opening T of the pixel P increases.

Thus, in the microlens ML2, a range capable of light concentration in the opening T of the pixel P can be increased, compared to the microlens ML2e of the related art. As a result, in the microlens array substrate 10 according to the first embodiment, even when the distance between the microlens ML1 and the microlens ML2 is smaller than that of the microlens array substrate of the related art, the light concentrated by the microlens ML1 can be incident to the inner side of the opening T of the pixel P.

Since the microlens ML2 has a convex portion shape projected to a side to which light is emitted, light incident to the peripheral portion 16b of the microlens ML2 from the microlens ML1 side to the outer side can be more strongly curved to the inner side, compared to a case where the microlens has a convex portion shape projected to a side to which light is incident. Therefore, it is possible to extend the range capable of light concentration in the opening T of the pixel P by the microlens ML2.

Meanwhile, the curvature of the center portion 16a is smaller than a curvature of a portion corresponding to the center portion 16a of the ellipse 19. Accordingly, an angle formed by the lens surface and the surface 11a of the substrate 11 (see FIG. 3) of the microlens ML2 in the center portion 16a is smaller than that of the microlens ML2e of the related art, and even at different positions, the angles are not greatly different.

Thus, an angle of incidence of light incident to the center portion 16a of the lens surface of the microlens ML2 along the normal direction from the positive Z direction side is smaller than that of light incident to this portion of the microlens ML2e of the related art, and a variation thereof is small. Therefore, a variation in refractive angles of light emitted to the element substrate 20 (see FIG. 3) side from the center portion 16a of the microlens ML2 is smaller than that of the microlens ML2e of the related art, and thus, a variation in angles of light incident to the center portion of the opening T of the pixel P is reduced.

As a result, in the microlens array substrate 10 according to the embodiment, concentration or deviation of distribution of illumination of the center portion of the opening T of the pixel P of the liquid crystal device 1 is alleviated to realize even distribution, and thus, more even brightness can be realized, compared to a case of the microlens array substrate of the related art. A degree of concentration of light on the center portion of the opening T of the pixel P is alleviated, thereby preventing a deterioration of light stability of liquid crystals of the liquid crystal layer 40 (see FIG. 3) during long-term use. Therefore, it is possible to realize a long life of the liquid crystal device 1.

The curvature of the peripheral portion 16c is smaller than a curvature of the portion corresponding to the peripheral portion 16c of the ellipse 19. Since the peripheral portion 16c is positioned on the end portion of the microlens ML2, a large quantity of light incident to the peripheral portion 16c is not incident to the inner portion of the opening T of the pixel P. Since the microlens ML2 includes such a peripheral portion 16c, the curvature of the peripheral portion 16b positioned between the center portion 16a and the peripheral portion 16c can be further increased, compared to a case where the peripheral portion 16c is not provided. Therefore, it is possible to further extend the range capable of light concentration by the microlens ML2 with respect to the light incident from the microlens ML1.

The cross section shape of the microlens ML2 is approximately symmetrical with respect to the apex of the convex portion 16. FIG. 4 shows an example in which the cross section shape of the convex portion 16 is symmetrical in the X axis direction, but it is preferable that the cross section shape be symmetrical even in the Y axis direction (see FIG. 1). The cross section shape of the convex portion 16 may be symmetrical over 360° with respect to the apex of the convex portion 16 in a plan view.

When the cross section shape of the microlens ML2 is approximately symmetrical with respect to the apex of the convex portion 16, light beams incident in the same direction (for example, normal direction) at the position symmetrical with respect to the apex of the convex portion 16 among the light beams incident to the microlens ML2 is refracted at the approximately same angle. Accordingly, a variation in angle of light emitted from the microlens ML2 is reduced. As a result, more even brightness in the opening T of the pixel P can be realized.

In FIG. 5, the microlens ML1 and the microlens ML2 according to the embodiment are disposed in the pixel P1. As a comparative example, the microlens ML1 according to the embodiment and the microlens ML2e of the related art are disposed in the pixel P2. In the pixel P1 and the pixel P2, light beams L4 and L5 are respectively emitted from the same position of the microlens ML1 at the same angle and are incident to the microlens ML2 and the microlens ML2e.

The light beam L4 is light incident to the end portion of the microlens ML1 along the normal direction, concentrated (refracted to the center side of the microlens ML1), and emitted. In the pixel P2, when a distance between the microlens ML2e of the related art and the microlens ML1 is small, it is difficult to concentrate the light L4 emitted from the microlens ML1 and cause the light L4 to be incident to the inner portion of the opening T of the pixel P2. Accordingly, in order to cause the light L4 to be incident in the range capable of being concentrated by the microlens ML2e of the related art and incident to the inner portion of the opening T of the pixel P2, it is necessary to provide a distance (optical path length) D2 between the microlens ML1 and the microlens ML2e.

Accordingly, in a case of including the microlens ML2e of the related art, it is necessary to provide an optical path length adjustment layer formed of a light transmitting layer having a refractive index which is approximately the same as the refractive index of the substrate 11 (see FIG. 3) to ensure the distance (optical path length) D2 between the microlens ML1 and the microlens ML2e, as in a case of the microlens array substrate disclosed in JP-A-2014-089230. By doing so, the thickness of the microlens array substrate increases. In a manufacturing step of the microlens array substrate, it is necessary to perform a step of forming the optical path length adjustment layer, thereby causing an increase in production cost.

Meanwhile, as described above, in the pixel P1, the microlens ML2 having a larger range capable of light concentration than that of the microlens ML2e of the related art is provided. Accordingly, even when a distance (optical path length) D1 between the microlens ML1 and the microlens ML2 is smaller than the distance (optical path length) D2, the light L4 can be concentrated by the microlens ML2 and incident to the inner portion of the opening T of the pixel P1.

Thus, in the microlens array substrate 10 according to the embodiment, the distance (optical path length) D1 between the microlens ML1 and the microlens ML2 can be decreased, and therefore, the optical path length adjustment layer is not necessary. As a result, the thickness of the microlens array substrate 10 can be decreased, compared to a case of the microlens array substrate of the related art. Since it is not necessary to perform the step of forming the optical path length adjustment layer, compared to a case of the microlens array substrate of the related art, it is possible to shorten a manufacturing lead time of the microlens array substrate 10 and reduce production cost. The manufacturing method of the microlens array substrate 10 will be described later.

The light L5 is light which is incident to the microlens ML1 obliquely with respect to the normal direction and emitted from the microlens ML1 to the outer side. In the pixel P2, the distance (optical path length) D2 is set between the microlens ML1 and the microlens ML2e of the related art, and thus, the light L5 is leaked to the adjacent pixel P1 side and is not incident to the microlens ML2e. Even when the light L5 is incident to the microlens ML2e, the light is refracted by the microlens ML2e and then shielded by a light shielding portion S.

In the pixel P1, since the distance (optical path length) D1 between the microlens ML1 and the microlens ML2 is small, the light L5 can be incident to the peripheral portion 16b of the microlens ML2. As described above, since the curvature of the peripheral portion 16b is greater than the curvature thereof in the microlens ML2e, the light L5 can be refracted at the peripheral portion 16b of the microlens ML2 and incident to the inner portion of the opening T of the pixel P1. Accordingly, in the microlens array substrate 10 according to the embodiment, it is possible to improve efficiency of utilization of light, compared to a case of the microlens array substrate of the related art.

Since a larger quantity of light can be concentrated on the peripheral portion 16b of the microlens ML2 and incident to the inner portion of the opening T of the pixel P1, compared to a case of the microlens ML2e of the related art, it is possible to prevent light from being reflected by the light shielding portion S (light shielding layer 26) or total reflection by the end portion side of the microlens ML2. Accordingly, generation of stray light generated by these reflected light beams can be reduced, and thus, it is possible to prevent a deterioration of display quality such as occurrence of flicker or unevenness in a display image due to generation of an optical leak current of the TFT 24 caused by the stray light. Thus, it is possible to improve display quality of the liquid crystal device 1. In addition, when a quantity of light incident to the light shielding portion S is decreased, it is possible to decrease the size of the light shielding portion S and to increase an aperture ratio of the opening T of the pixel P1 to improve brightness.

As described above, according to the configuration of the microlens array substrate 10 according to the embodiment, since the optical path length adjustment layer which was necessary in the related art is not necessary, it is possible to decrease the distance between the microlens ML1 and the microlens ML2. By decreasing the distance between the microlens ML1 and the microlens ML2, it is possible to cause oblique light which was not used in the related art to be incident to the microlens ML2 and used. Accordingly, it is possible to provide the microlens array substrate 10 and the liquid crystal device 1 which are thin and has high efficiency of utilization of light. The configuration of the microlens array substrate 10 according to the embodiment is suitable for the liquid crystal device 1 in which the arrangement pitch of the pixels P is minute, and is, for example, effective for the liquid crystal device 1 in which the arrangement pitch of the pixels P is equal to or smaller than 10 μm.

Meanwhile, according to the configuration of the microlens array substrate 10 according to the embodiment, the microlens ML2 having a larger range capable of light concentration than the microlens ML2e of the related art is included to have two stages, thereby decreasing a light-gathering power (refractive power) of the microlens ML1 in the first stage than that in the related art. When the refractive power of the microlens ML1 is decreased, it is possible to decrease the depth of the recess 12. By doing so, it is possible to decrease an etching amount when forming the recess 12 on the substrate 11. Therefore, it is possible to decrease the thickness of the lens layer 13 formed by filling the recess 12 and to decrease the amount subjected for a CMP process when flattening the surface of the lens layer 13. Accordingly, it is possible to reduce the number of steps of the CMP process, thereby further reducing production cost of the microlens array substrate 10.

When the refractive power of the microlens ML1 is decreased, it is possible to decrease a difference in refractive index between the substrate 11 and the lens layer 13. By doing so, it is possible to reduce occurrence of Fresnel reflection on the interface between the substrate 11 and the lens layer 13, thereby reducing light loss due to the Fresnel reflection. Therefore, it is possible to further improve efficiency of utilization of light.

### Manufacturing Method of Microlens Array Substrate

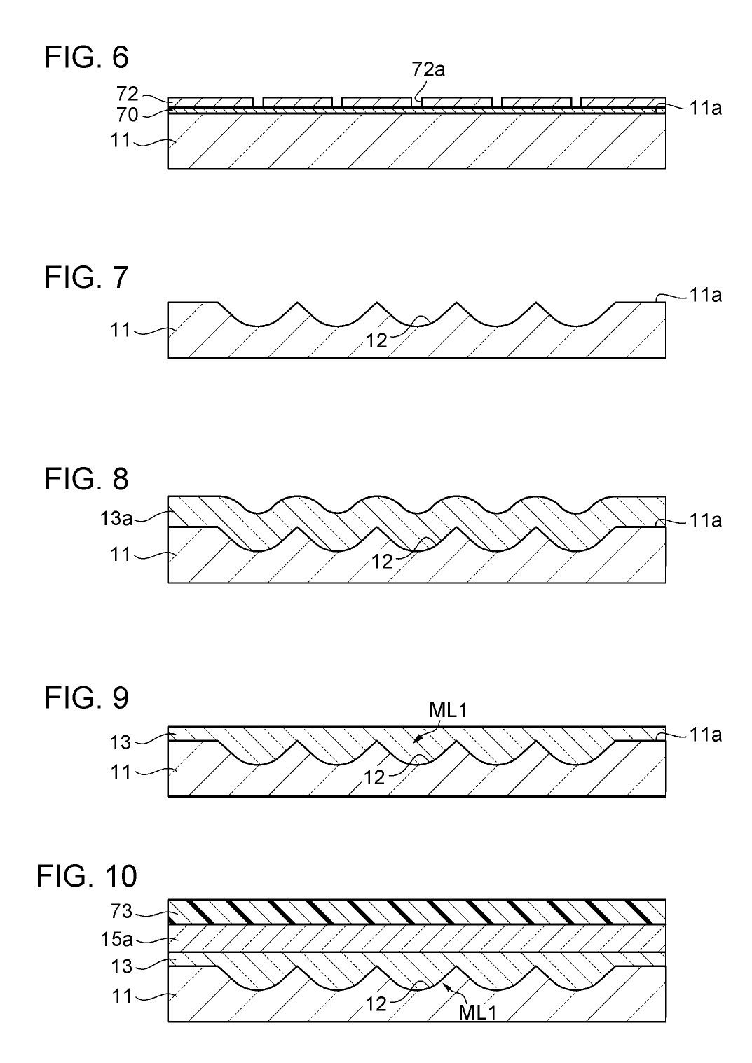

Next, a manufacturing method of the microlens array substrate 10 according to the first embodiment will be described. FIGS. 6 to 15 are schematic sectional views showing the manufacturing method of the microlens array substrate according to the first embodiment. Specifically, each drawing of FIGS. 6 to 15 corresponds to a schematic sectional view taken along line A-A of FIG. 1 and the vertical direction (Z direction) is reversed compared to that in FIG. 3.

First, as shown in FIG. 6, a control film 70 formed of an oxide film such as SiO₂, for example, is formed on the surface 11a of the substrate 11 having light transmittance formed of quartz. An etching rate of isotropic etching of the control film 70 is different from that of the substrate 11 and has a function of adjusting the etching rate in a width direction (X direction and Y direction shown in FIG. 3) with respect to the etching rate in a depth direction (Z direction) when forming the recess 12.

After the control film 70 is formed, annealing of the control film 70 is performed at a predetermined temperature. The etching rate of the control film 70 changes depending on the temperature at the time of annealing. Accordingly, by suitably setting the temperature at the time of annealing, it is possible to adjust the etching rate of the control film 70.

Next, a mask layer 72 is formed on the control film 70. The mask layer 72 is patterned and openings 72a are formed on the mask layer 72. A planar center position of each opening 72a is the center of the recess 12 to be formed. Then, the isotropic etching is performed with respect to the substrate 11 covered with the control film 70 through the openings 72a of the mask layer 72. Although not shown, openings are formed in a region overlapped with the openings 72a of the control film 70 by performing the isotropic etching, and the substrate 11 is etched through the openings.

In the isotropic etching, an etching solution (for example, hydrofluoric acid solution) for causing the etching rate of the control film 70 to be greater than the etching rate of the substrate 11 is used. Accordingly, since the etching amount per unit time of the control film 70 of the isotropic etching is greater than the etching amount per unit time of the substrate 11, the etching amount of the substrate 11 in the width direction is increased than the etching amount thereof in the depth direction, in accordance with expansion of the openings formed on the control film 70.

The control film 70 and the substrate 11 are etched from the openings 72a by the isotropic etching, and as shown in FIG. 7, the recesses 12 are formed on the surface 11a side of the substrate 11. By setting the etching rate described above, the recess 12 is expanded in the width direction than in the depth direction, and a tapered inclined surface is formed on the peripheral portion of the recess 12. In a case of forming the recess 12 entirely configured with a curved surface, the control film 70 may not be provided. FIG. 7 shows a state after the mask layer 72 and the control film 70 are removed.

In this step, it is preferable to finish the isotropic etching in a state where adjacent recesses 12 are connected to each other in the X direction and the Y direction in which the pixels P are arranged, and adjacent recesses 12 are separated from each other in a diagonal direction of the pixels P (hereinafter, simply referred to as a diagonal direction), that is, a state where the surface 11a of the substrate 11 has remained between the adjacent recesses 12 in the diagonal direction.

When the isotropic etching is performed until the adjacent recesses 12 are connected to each other in the diagonal direction, the mask layer 72 may float and be peeled from the substrate 11. When the isotropic etching is finished in a state where the surface 11a of the substrate 11 remains between the adjacent recesses 12, it is possible to more reliably support the mask layer 72 until the isotropic etching is finished.

Next, as shown in FIG. 8, a lens material layer 13a is formed by accumulating an inorganic material having light transmittance and having a refractive index greater than that of the substrate 11, so as to cover the surface 11a side of the substrate 11 and fill the recess 12. The lens material layer 13a can be formed by using a CVD method, for example. Since the lens material layer is formed so as to fill the recesses 12, the surface of the lens material layer 13a has an uneven shape obtained by reflecting unevenness caused by the recesses 12 of the substrate 11. The lens material layer 13a may be formed in a single film formation or may be formed in the plurality of times of the film formation.

Next, as shown in FIG. 9, a flattening process is performed with respect to the lens material layer 13a. In the flattening process, a portion of the upper layer of the lens material layer 13a where unevenness is formed is polished and removed by using a chemical mechanical polishing (CMP) process, for example, thereby flattening the upper surface and forming the lens layer 13. The microlens ML1 is configured by filling the recesses 12 with the material of the lens layer 13. In the embodiment, the flattening process is finished in a state where the lens layer 13 remains on the surface 11a of the substrate 11.

As the depth of the recess 12 is small, it is possible to decrease the etching amount in the step of forming the recesses 12 on the substrate 11 (see FIG. 7), and it is possible to decrease the amount of films formed in the step of filling the recesses 12 and forming the lens material layer 13a (see FIG. 8). That is, it is possible to decrease the thickness of the lens material layer 13a. By doing so, it is possible to decrease the amount subjected for the CMP process in the step of performing the flattening process with respect to the lens material layer 13a (see FIG. 9). These contribute to the shortening of the manufacturing lead time or the reduction of the production cost of the microlens array substrate 10.

Next, as shown in FIG. 10, an inorganic material having light transmittance and having a refractive index greater than that of the substrate 11 is accumulated to cover the lens layer 13 and a first lens material layer 15a is formed. The first lens material layer 15a can be, for example, formed by the CVD method. In the microlens array substrate of the related art, the optical path length adjustment layer is formed between the lens layer 13 and the lens layer 15 which is the upper layer, but the optical path length adjustment layer is not formed in the microlens array substrate 10 according to the embodiment. Accordingly, compared to the microlens array substrate of the related art, it is not necessary to perform the step of forming the optical path length adjustment layer, and therefore, it is possible to shorten a manufacturing lead time of the microlens array substrate 10 and reduce production cost.

Next, as shown in FIG. 10, a resist layer 73 is formed on a first lens material layer 15a. The resist layer 73 is, for example, formed of a positive type photosensitive resist in which an exposure portion is removed by development. The resist layer 73 can be, for example, formed by a spin coating method or a roll coating method.

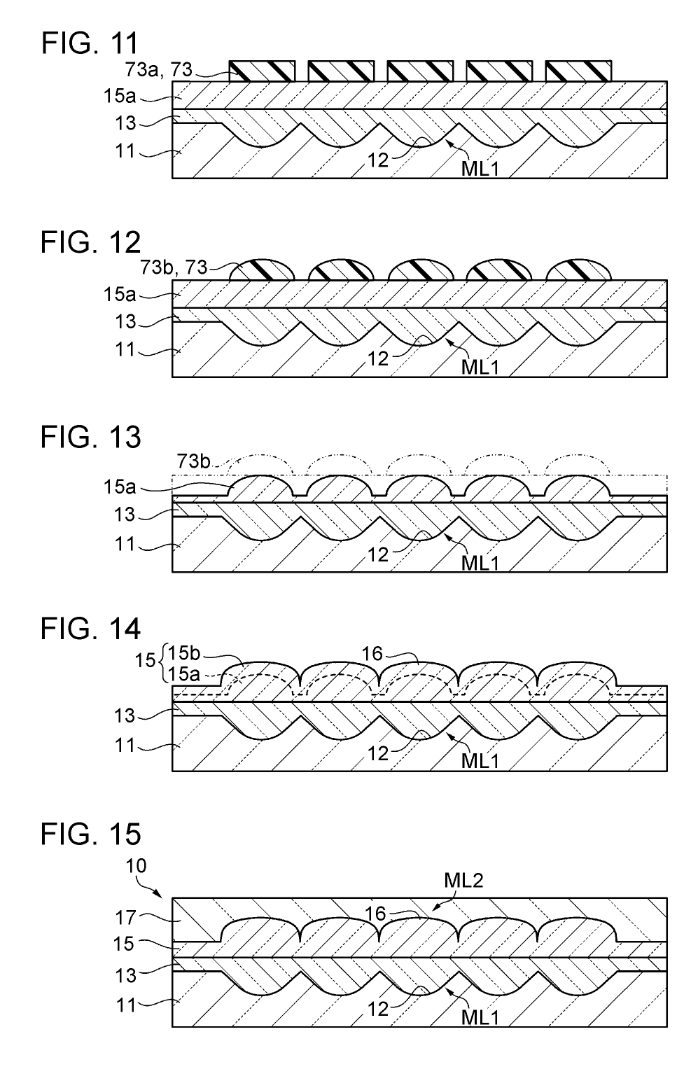

Next, although not shown, the resist layer 73 is exposed and developed through a mask in which the light shielding portion is provided to correspond to the position of the recess 12. Accordingly, as shown in FIG. 11, among the resist layer 73, a region other than a region overlapped with the light shielding portion of the mask is exposed and removed, and portions 73a corresponding to the positions in which the convex portions 16 are formed in the latter step remain. Thus, the remaining portions 73a are separated from each other in the X direction, the Y direction, and the diagonal direction. The planar shape of the portion 73a is, for example, an approximately rectangular shape, and round four corners may be formed.

In the step which will be described later, the microlens ML2 (convex portion 16) is formed in the portion overlapped with the portion 73a of the first lens material layer 15a. In the microlens array substrate 10 according to the embodiment, it is possible to decrease the distance between the microlens ML1 and the microlens ML2, without forming the optical path length adjustment layer, compared to the microlens array substrate of the related art. Accordingly, a deviation of the mask at the time of exposing the resist layer 73 is prevented, thereby improving a position accuracy of the microlens ML2 with respect to the microlens ML1.

Next, a heating process such as reflow treatment is performed with respect to the remaining portion 73a among the resist layer 73 to softening (melting) the portion. The melted portion 73a is in a flow state and the surface is deformed in a curved surface shape due to the operation of surface tension. Accordingly, as shown in FIG. 12, convex portions 73b having a curved surface shape are formed from the portions 73a remaining on the first lens material layer 15a. A bottom side (first lens material layer 15a side) of the convex portion 73b has an approximately rectangular shape in a plan view, and a tip (upper) side of the convex portion 73b is formed in an approximately concentric circle shape in a plan view.

Next, as shown in FIG. 13, the anisotropic etching such as dry etching, for example, is performed with respect to the convex portions 73b and the first lens material layer 15a from the upper side. Accordingly, the convex portion 73b formed of the resist is gradually removed, and the exposed portion of the first lens material layer 15a is etched in accordance with the convex portion 73b. As a result, the shape of the convex portion 73b is reflected on the surface side of the first lens material layer 15a. In this step, the anisotropic etching is finished in a state where the first lens material layer 15a remains on the lens layer 13 (the surface of the lens layer 13 is not exposed).

By setting the etching conditions in this step as conditions in which the etching rate of the material (resist) of the convex portion 73b and the etching rate of the material of the first lens material layer 15a can be set approximately the same as each other, it is possible to transfer the shape of the convex portion 73b to the first lens material layer 15a.

Next, as shown in FIG. 14, the inorganic material having a refractive index greater than that of the substrate 11 is accumulated so as to cover the first lens material layer 15a by using the CVD method, for example, and the second lens material layer 15b is formed. By accumulating the second lens material layer 15b on the first lens material layer 15a, the lens layer 15 including the convex portion 16 obtained by enlarging the shape of the convex portion 73b is formed. The refractive index of the second lens material layer 15b may be the same as the refractive index of the first lens material layer 15a and may be greater than the refractive index of the first lens material layer 15a. The second lens material layer 15b may be formed in a single film formation or may be formed in the plurality of times of the film formation.

Next, as shown in FIG. 15, an inorganic material having light transmittance and having a refractive index approximately the same as that of the substrate 11, for example, is accumulated and the flattening layer 17 is formed, so as to cover the lens layer 15. The flattening process is performed with respect to the flattening layer 17. The microlens ML2 is configured by covering the convex portions 16 with the flattening layer 17. As described above, the microlens array substrate 10 is completed.

By forming the second lens material layer 15b on the first lens material layer 15a, the cross section shape of the convex portion 16 shown in FIG. 4 is formed by enlarging the shape obtained by reflecting the shape of the convex portion 73b of the first lens material layer 15a (see FIG. 14). Accordingly, the cross section shape of the convex portion 73b formed from the resist layer 73 (see FIG. 12) is suitably set based on the cross section shape after performing the anisotropic etching with respect to the first lens material layer 15a (see FIG. 13) or the cross section shape after the second lens material layer 15b is formed (see FIG. 14).

The cross section shape of the convex portion 73b can be adjusted by the treatment conditions when the heating process is performed with respect to the portion 73a remaining among the resist layer 73. The resist layer 73 shown in FIG. 10 may be, for example, processed from the shape of the resist layer 73 to the convex portion 73b by using a method of performing the exposure by using a grayscale mask or an area gradation mask or a method of performing multistage exposure, instead of the heating process.

After completing the microlens array substrate 10, the light shielding layer 32, the protective layer 33, the common electrode 34, and the orientation film 35 are formed on the microlens array substrate 10 in this order by using a well-known technology, to obtain the counter substrate 30. By forming the light shielding layer 22, the insulating layer 23, the TFT 24, the insulating layer 25, the light shielding layer 26, the insulating layer 27, the pixel electrode 28, and the orientation film 29 on the substrate 21 in this order by a well-known method, the element substrate 20 is obtained.

Next, the element substrate 20 and the counter substrate 30 are positioned, and a thermosetting or photo-curable adhesive is disposed and cured between the element substrate 20 and the counter substrate 30 as the sealing material 42 (see FIG. 1) and bonds the element substrate and the counter substrate to each other. Liquid crystals are sealed and interposed in the space configured with the element substrate 20, the counter substrate 30, and the sealing material 42, thereby completing the liquid crystal device 1. Liquid crystals may be disposed in a region surrounded by the sealing material 42 before bonding the element substrate 20 and the counter substrate 30 to each other.

### Electronic Apparatus

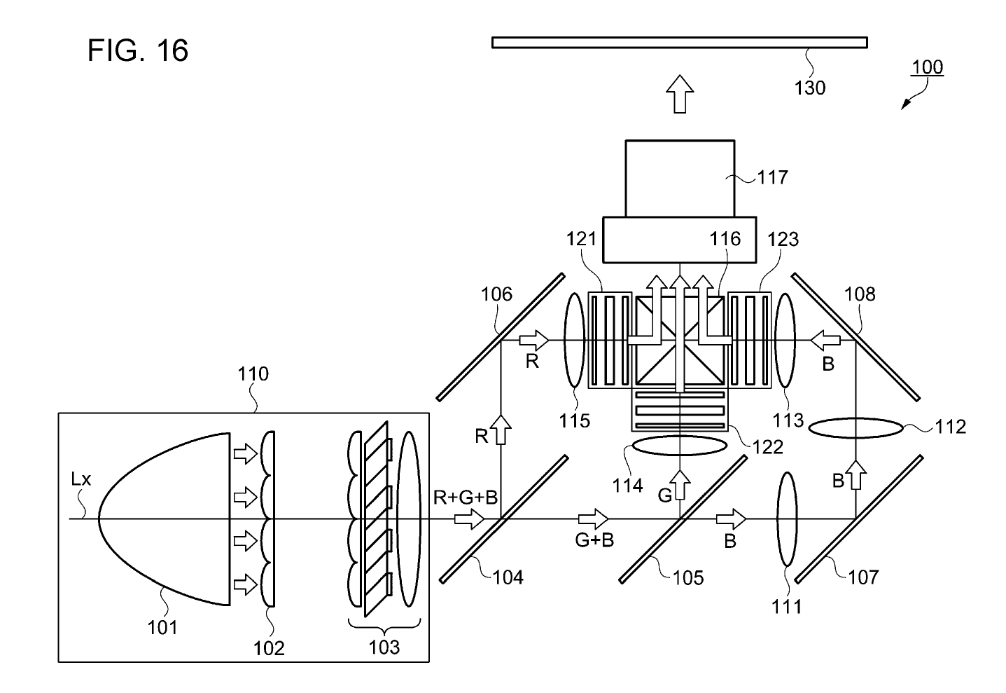

Next, an electronic apparatus according to the first embodiment will be described with reference to FIG. 16. FIG. 16 is a schematic view showing a configuration of a projector as the electronic apparatus according to the first embodiment.

As shown in FIG. 16, a projector (convex portion type display apparatus) 100 as the electronic apparatus according to the first embodiment includes a polarized light illumination device 110, two dichroic mirrors 104 and 105, three reflecting mirrors 106, 107, and 108, five relay lenses 111, 112, 113, 114, and 115, three liquid crystal light bulbs 121, 122, and 123, a cross dichroic prism 116, and a convex portion lens 117.

The polarized light illumination device 110, for example, includes a lamp unit 101 as a light source formed of white light source such as an ultra-high pressure mercury lamp or a halogen lamp, an integrator lens 102, and a polarization conversion element 103. The lamp unit 101, the integrator lens 102, and the polarization conversion element 103 are disposed along a system optical axis Lx.

The dichroic mirror 104 reflects red light (R) and transmits green light (G) and blue light (B) among polarized light beams emitted from the polarized light illumination apparatus 110. The other dichroic mirror 105 reflects the green light (G) which is transmitted through the dichroic mirror 104 and transmits the blue light (B).

The red light (R) reflected by the dichroic mirror 104 is reflected by the reflecting mirror 106 and then is incident to the liquid crystal light bulb 121 through the relay lens 115. The green light (G) reflected by the dichroic mirror 105 is incident to the liquid crystal light bulb 122 through the relay lens 114. The blue light (B) which is transmitted through the dichroic mirror 105 is incident to the liquid crystal light bulb 123 through an optical guiding system configured with the three relay lenses 111, 112, and 113 and the two reflecting mirrors 107 and 108.

The transmission type liquid crystal light bulbs 121, 122, and 123 as optical modulation elements are respectively disposed to face surfaces of incidence of colored light beams of the cross dichroic prism 116. The colored light beams incident of the liquid crystal light bulbs 121, 122, and 123 are modulated based on moving image information (moving image signals) and emitted towards the cross dichroic prism 116.

The cross dichroic prism 116 is configured by bonding four rectangular prisms to each other, and in the inner surfaces thereof, a dielectric multilayer film reflecting red light and a dielectric multilayer film reflecting blue light are formed in a cross shape. Three colored light beams are synthesized by these dielectric multilayer film, and light displaying a color image is synthesized. The synthesized light is projected on a screen 130 by the convex portion lens 117 which is a convex portion optical system and an enlarged image is displayed.

The liquid crystal light bulb 121 is disposed between a pair of polarization elements disposed in a crossed Nichol prism with a gap therebetween at an incidence side and an emission side of the colored light. The same applies to the other liquid crystal light bulbs 122 and 123. The liquid crystal device 1 is applied to the liquid crystal light bulbs 121, 122, and 123.

According to the configuration of the projector 100 according to the first embodiment, even when the plurality of pixels P are highly precisely disposed, the liquid crystal device 1 capable of obtaining high efficiency of utilization of incident light from a light source and realizing bright display and excellent display quality, is included in the liquid crystal light bulbs 121, 122, and 123, and therefore, it is possible to provide the projector 100 realizing bright display and excellent display quality.

### Second Embodiment

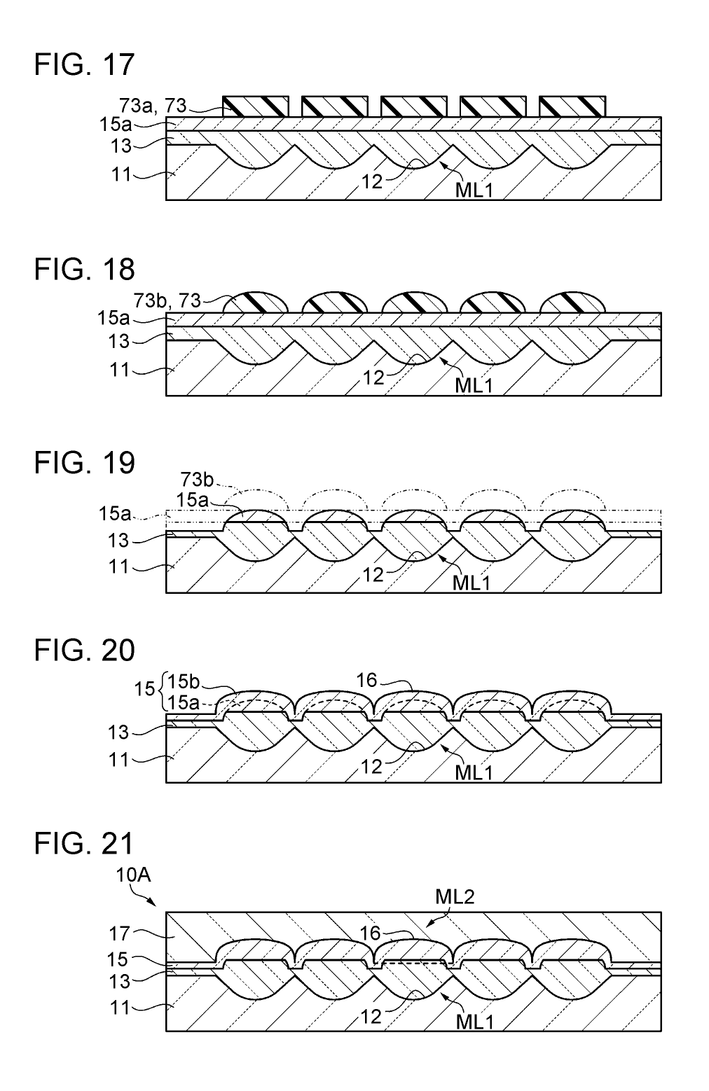

In a second embodiment, a manufacturing method of a microlens array substrate is different and a configuration of a second microlens is different according to the difference of the manufacturing method, from those in the first embodiment, but the basic configuration of the liquid crystal device is the same as that in the first embodiment. Here, the manufacturing method of a microlens array substrate according to the second embodiment will be described with reference to FIGS. 17 to 21. Manufacturing Method of Microlens Array Substrate

FIGS. 17 to 21 are schematic sectional views showing the manufacturing method of the microlens array substrate according to the second embodiment. Steps shown in each drawing of FIGS. 17 to 21 correspond to the step shown in each drawing of FIGS. 11 to 15 of the first embodiment. Here, the different parts from those in the first embodiment will be described and the descriptions of the same constituent elements as those in the first embodiment will be omitted by using the same reference numerals.

The second embodiment is different from the first embodiment in that the first lens material layer 15a formed on the lens layer 13 is formed to be thinner. FIG. 17 shows a state where the resist layer 73 is exposed and portions 73a corresponding to the positions in which the convex portions 16 are formed in the latter step remain. As shown in FIG. 17, in the second embodiment, the first lens material layer 15a is, for example, formed to have a smaller thickness than that of the resist layer 73 to be formed thereon.

Next, as shown in FIG. 18, in the same manner as in the first embodiment, a heating process such as reflow treatment is performed with respect to the remaining portion 73a among the resist layer 73 to form convex portions 73b having a curved surface shape on the first lens material layer 15a.

Next, as shown in FIG. 19, the anisotropic etching is performed with respect to the convex portions 73b and the first lens material layer 15a from the upper side. The anisotropic etching is performed until the convex portions 73b (resist layer 73) are removed. By doing so, the thickness of the first lens material layer 15a is smaller than the thickness of the resist layer 73, and therefore, the portions of the first lens material layer 15a other than the portions overlapped with the convex portions 73b are removed and the surface of the lens layer 13 on the lower layer is also etched.

As a result, the shapes of the convex portions 73b are reflected on the remaining portions of the lens layer 13 and the first lens material layer 15a. In this step, the anisotropic etching is finished in a state where the lens layer 13 remains on the substrate 11. At the time point when the anisotropic etching is finished, the flattened surface of the lens layer 13 remains.

Next, as shown in FIG. 20, the inorganic material having a refractive index greater than that of the substrate 11 is accumulated so as to cover the lens layer 13 and the first lens material layer 15a by using the CVD method, for example, and the second lens material layer 15b is formed. The refractive index of the second lens material layer 15b may be the same as the refractive index of the first lens material layer 15a and may be greater than the refractive index of the first lens material layer 15a. The second lens material layer 15b may be formed in a single film formation or may be formed in the plurality of times of the film formation. The lens layer 15 is configured with the first lens material layer 15a and the second lens material layer 15b. The thickness of the lens layer 15 is smaller than that in the first embodiment.

Next, as shown in FIG. 21, in the same manner as in the first embodiment, the flattening layer 17 is formed so as to cover the lens layer 15. The flattening process is performed with respect to the flattening layer 17. By doing so, a microlens array substrate 10A according to the second embodiment is completed.

The microlens array substrate 10A according to the second embodiment is different from that in the first embodiment, in that the flattened surface of the lens layer 13 configuring the microlens ML1 is included in the cross section shape of the microlens ML2 (convex portion 16) shown with a broken line in FIG. 21. That is, the microlens ML2 (convex portion 16) is configured with a part (surface side) of the lens layer 13 and the lens layer 15.

According to the configuration of the microlens array substrate 10A according to the second embodiment, the thickness of the lens layer 15 configuring the microlens ML2 (convex portion 16) can be decreased, compared to that in the first embodiment, and therefore, it is possible to further decrease the distance between the microlens ML1 and the microlens ML2. Thus, in the liquid crystal device 1 in which the arrangement pitch of pixels P is minute, it is possible to improve efficiency of utilization of light.

### Third Embodiment

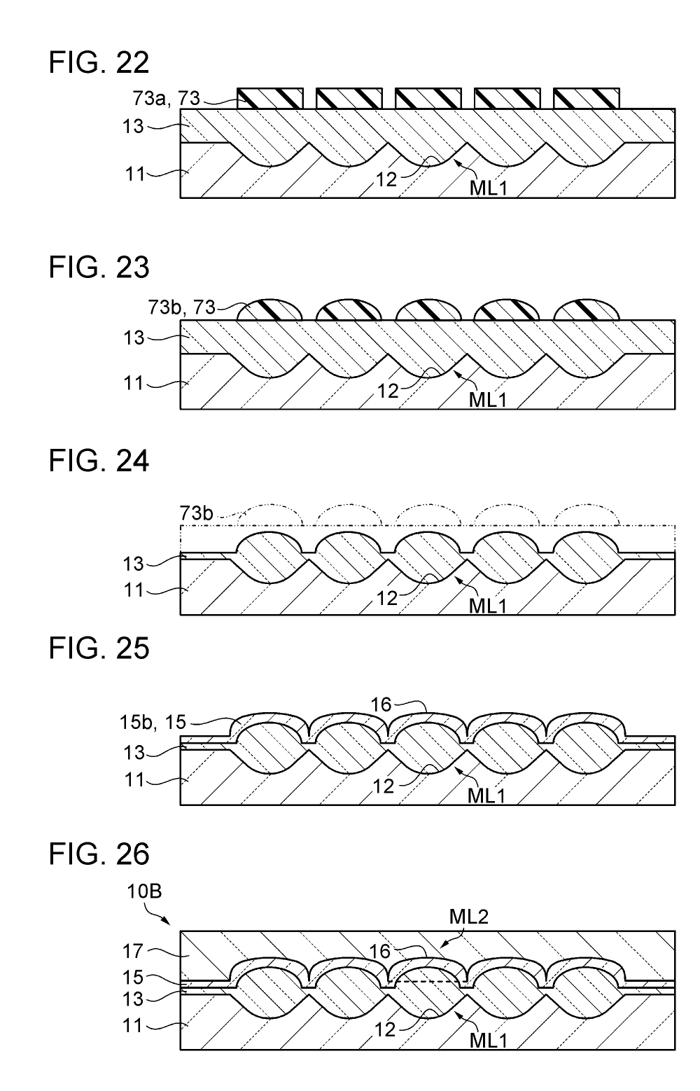

In a third embodiment, a manufacturing method of a microlens array substrate is different and a configuration of a second microlens is different according to the difference of the manufacturing method, from those in the first embodiment, but the basic configuration of the liquid crystal device is the same as that in the first embodiment. Here, the manufacturing method of a microlens array substrate according to the third embodiment will be described with reference to FIGS. 22 to 26.

### Manufacturing Method of Microlens Array Substrate

FIGS. 22 to 26 are schematic sectional views showing the manufacturing method of the microlens array substrate according to the third embodiment. Steps shown in each drawing of FIGS. 22 to 26 correspond to the step shown in each drawing of FIGS. 11 to 15 of the first embodiment. Here, the different parts from those in the first embodiment will be described and the descriptions of the same constituent elements as those in the first embodiment will be omitted by using the same reference numerals.

The third embodiment is different from the first embodiment in that the lens layer 13 formed on the substrate 11 is formed to be thicker and the first lens material layer 15a is not formed. FIG. 22 shows a state where the resist layer 73 is exposed and portions 73a corresponding to the positions in which the convex portions 16 are formed in the latter step remain. As shown in FIG. 22, the lens layer 13 is formed to be thicker than that in the first embodiment. The first lens material layer 15a is not formed on the lens layer 13.

Next, as shown in FIG. 23, in the same manner as in the first embodiment, a heating process such as reflow treatment is performed with respect to the remaining portion 73a among the resist layer 73 to form convex portions 73b having a curved surface shape on the lens layer 13.

Next, as shown in FIG. 24, the anisotropic etching is performed with respect to the convex portions 73b and the lens layer 13 from the upper side. In this step, the anisotropic etching is performed until the flattened surface of the lens layer 13 does not remain. As a result, the shapes of the convex portions 73b are reflected on the surface side of the lens layer 13.

Next, as shown in FIG. 25, the inorganic material having a refractive index greater than that of the substrate 11 is accumulated so as to cover the lens layer 13 by using the CVD method, for example, and the second lens material layer 15b is formed. The second lens material layer 15b may be formed in a single film formation or may be formed in the plurality of times of the film formation. In the third embodiment, the lens layer 15 is configured with the second lens material layer 15b.

Next, as shown in FIG. 26, in the same manner as in the first embodiment, the flattening layer 17 is formed so as to cover the lens layer 15. The flattening process is performed with respect to the flattening layer 17. By doing so, a microlens array substrate 10B according to the third embodiment is completed.

The microlens array substrate 10B according to the third embodiment is different from that in the first embodiment in that the lens layer 13 configuring the microlens ML1 is included in the cross section shape of the microlens ML2 (convex portion 16) shown with a broken line in FIG. 26, and is different from that in the second embodiment in that the flattened surface of the lens layer 13 does not remain. According to the configuration of the microlens array substrate 10B according to the third embodiment, it is not necessary to perform the step of forming the first lens material layer 15a, and thus, the manufacturing lead time can be shortened and production cost can be reduced, compared to the cases in the first embodiment and the second embodiment.

### Fourth Embodiment

### Electrooptical Device

In a fourth embodiment, a complementary metal oxide semiconductor (CMOS) type imaging device will be described as an example of the electrooptical device. This imaging device can be, for example, suitably used as an imaging device of a video camera which will be described later. The electrooptical device may be a charge coupled device (CCD) type imaging device.

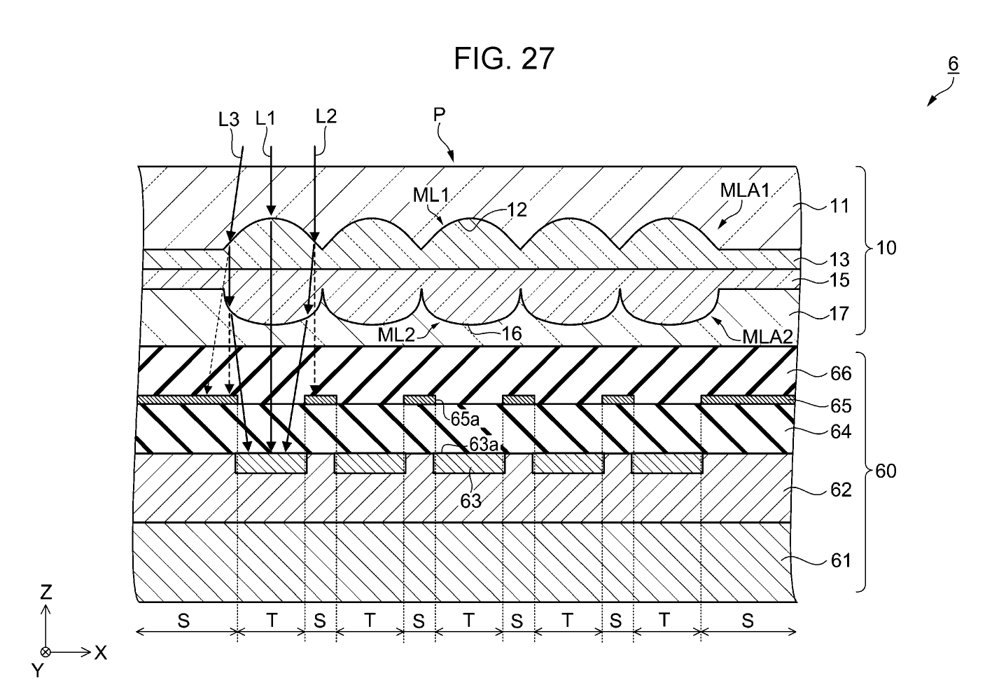

FIG. 27 is a schematic sectional view showing a configuration of the imaging device according to the fourth embodiment. The description of the common constituent elements as those in the first embodiment is omitted by using the same reference numerals. As shown in FIG. 27, the imaging device 6 according to the fourth embodiment includes a light receiving element substrate 60 as a first substrate and the microlens array substrate 10 (10A or 10B) as a second substrate. In the imaging device 6, the microlens array substrate 10 corresponds to the second substrate.

Although the plan view is not shown, the pixel P has an approximately polygonal (for example, approximately rectangular) planar shape and the pixels are arranged in a matrix shape. A light receiving element 63 and a pixel transistor (so-called CMOS transistor) not shown are provided in each of the plurality of pixels P. The microlens ML1 and the microlens ML2 provided in the microlens array substrate 10 are disposed in each of the plurality of pixels P so as to be overlapped with the light receiving element 63 in a plan view.

The light receiving element substrate 60 includes a substrate 61, a semiconductor layer 62, the light receiving element 63, an interlayer insulating layer 64, a light shielding layer 65, and a flattening layer 66. The substrate 61 is, for example, a semiconductor substrate formed of silicon. The semiconductor layer 62 is provided on the substrate 61, and the light receiving element 63 configured of a photodiode is provided in the semiconductor layer 62.

The light receiving element 63 is configured with a photoelectric conversion element such as a photodiode. The light receiving element 63 includes a light receiving surface 63a. The light receiving element 63 generates signal charge according to a light quantity (light intensity) of light incident to the light receiving surface 63a by photoelectric conversion and accumulates the generated signal charge. A pixel transistor is, for example, configured with a plurality of transistors such as a transfer transistor, a reset transistor, and an amplifying transistor.

The interlayer insulating layer 64 is provided so as to cover the semiconductor layer 62 and the light receiving element 63. The interlayer insulating layer 64 is, for example, formed of an inorganic material such as SiO₂.

The light shielding layer 65 is provided on the interlayer insulating layer 64 in a lattice shape in a plan view. The light shielding layer 65 is, for example, formed of a metal or a metal oxide. A light shielding portion S is configured with the light shielding layer 65, and a region (inner portion of the opening 65a) surrounded by the light shielding layer 65 is set as an opening T through light is transmitted among the region of the pixel P. By providing the light shielding layer 65, light transmitted through the microlens ML1 and the microlens ML2 can be prevented from being incident to the light receiving element 63 of adjacent pixel P.

The flattening layer 66 is provided so as to cover the interlayer insulating layer 64 and the light shielding layer 65 and has an approximately flat surface. The flattening layer 66 may be formed of an inorganic material such as SiO₂ or may be formed of a resin material such as acryl. The microlens array substrate 10 is disposed so as to face the flattening layer 66 side of the light receiving element substrate 60.

The imaging device 6 according to the fourth embodiment includes the microlens array substrate 10 which concentrates incident light. Accordingly, in the imaging device 6, not only the light L1 incident to the center of the microlens ML1 along the normal direction, the light L2 incident to the end portion of the microlens ML1 along the normal direction or the light L3 obliquely incident thereto can also be refracted to the center side of the opening T of the pixel P and transmitted through the inner portion of the opening T.

The microlens array substrate 10 which is thinner and has higher efficiency of utilization of light than that in the related art is included. Accordingly, compared to the microlens array substrate of the related art, the quantity of light incident to the light receiving element 63 can be further increased, thereby improving light sensitivity. The quantity of stray light generated by the reflected light which is reflected by the light shielding portion S or total reflection by the end portion side of the microlens ML2 is decreased, and thus, noise caused by the stray light is reduced in the signal charge generated by the light receiving element 63. Therefore, it is possible to improve an S/N ratio and resolution of gradation.

### Electronic Apparatus

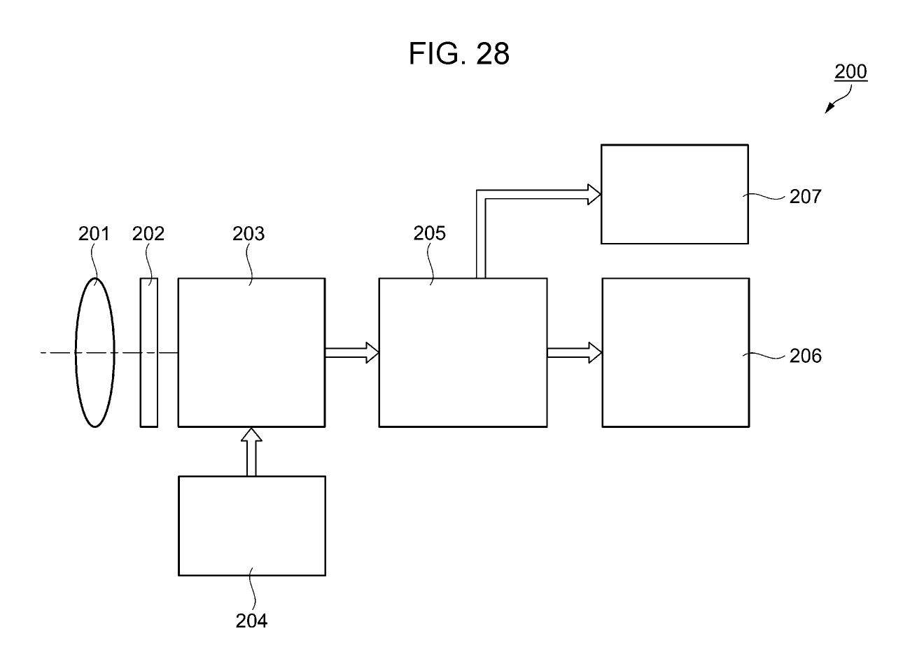

Next, an electronic apparatus according to the fourth embodiment will be described with reference to FIG. 28. FIG. 28 is a schematic view showing a configuration of a video camera as the electronic apparatus according to the fourth embodiment. A video camera 200 according to the fourth embodiment is an electronic apparatus capable of imaging a still image and a moving image.

As shown in FIG. 28, the video camera 200 as the electronic apparatus according to the fourth embodiment includes an optical unit 201, a shutter unit 202, an imaging unit 203, a driving unit 204, a signal processing unit 205, a monitor 206, and a memory 207. The imaging device 6 according to the embodiment is applied to the imaging unit 203. In addition, the liquid crystal device 1 according to the first embodiment is applied to the monitor 206.

The optical unit 201 is configured with one or a plurality of lenses, introduces light (incident light) from a subject to the imaging unit 203, and performs imaging on the light receiving surface 63a (see FIG. 27) of the light receiving element 63 of the imaging unit 203. The shutter unit 202 is disposed between the optical unit 201 and the imaging unit 203, and the time of light irradiation on the imaging unit 203 and time of light shielding are controlled based on the control of the driving unit 204.

The imaging unit 203 accumulates signal charge for a certain period of time, in accordance with light imaged on the light receiving surface 63a through the optical unit 201 and the shutter unit 202. The signal charge accumulated in the imaging unit 203 is transferred according to a driving signal (timing signal) supplied from the driving unit 204. The imaging unit 203 may be included as a part of a module configured with the optical unit 201 or the signal processing unit 205.

The driving unit 204 outputs a driving signal for controlling a transfer operation of the imaging unit 203 and a shutter operation of the shutter unit 202 and drives the imaging unit 203 and the shutter unit 202. The signal processing unit 205 performs various signal processes with respect to the signal charge output from the imaging unit 203. An image (image data) obtained by the signal process performed by the signal processing unit 205 is supplied to and displayed on the monitor 206, and supplied to and stored (recorded) in the memory 207.

According to the video camera 200 according to the fourth embodiment, since the imaging device 6 realizing improvement of light receiving sensitivity and improvement of an S/N ratio and resolution of gradation is included, it is possible to provide the video camera 200 capable of imaging a bright image having excellent resolution. By improving an S/N ratio and resolution of gradation, it is possible to further simplify the signal processing of the signal processing unit 205, and thus, it is possible to increase a signal processing speed and reduce the cost. In addition, since the liquid crystal device 1 capable of realizing bright display and excellent display quality is included, it is possible to provide the video camera 200 capable of display a bright image with excellent display quality on the monitor 206.

The embodiments described above are merely aspects of the invention, and therefore, arbitrary modifications and application can be performed within the scope of the invention. The followings are, for example, considered as modification examples.

### MODIFICATION EXAMPLE 1

In the microlens array substrate 10 according to the first embodiment, the optical path length adjustment layer is not provided between the lens layer 13 and the lens layer 15, but the invention is not limited thereto, and the optical path length adjustment layer may be provided between the lens layer 13 and the lens layer 15. Even when the optical path length adjustment layer may be provided between the lens layer 13 and the lens layer 15, it is possible to decrease the distance between the microlens ML1 and the microlens ML2, and therefore, it is possible to decrease the thickness of the optical path length adjustment layer, compared to the case of the microlens array substrate in the related art.

### MODIFICATION EXAMPLE 2

The electronic apparatus to which the liquid crystal device 1 according to the first embodiment can be applied is not limited to the projector 100 or the video camera 200. The liquid crystal device 1 can be, for example, suitably used as a convex portion type head-up display (HUD) or a direct viewing type head mount display (HMD), a display unit of an electronic book, a personal computer, a digital still camera, a liquid crystal television, a view finder type video camera, a car navigation system, an electronic notebook, or an information terminal device such as a POS.

The electronic apparatus to which the imaging device 6 according to the fourth embodiment can be applied is not limited to the video camera 200. The imaging device 6 can be suitably used as an imaging unit of a digital still camera or an information terminal device such as a mobile phone or a smart phone having an imaging function.

The entire disclosure of Japanese Patent Application No. 2016-215973, filed Nov. 4, 2016 is expressly incorporated by reference herein.

What is claimed is:

1. A microlens array substrate comprising:
a substrate;
a first microlens that is disposed on the substrate; and
a second microlens that is disposed on the first microlens so as to be overlapped with the first microlens in a plan view,
wherein the second microlens is configured with a curved surface and includes a center portion and a first peripheral portion that is disposed on the outer side of the center portion, and
a curvature of the first peripheral portion is larger than a curvature of the center portion.

2. The microlens array substrate according to claim 1,
wherein the second microlens includes a second peripheral portion that is disposed on the outer side of the first peripheral portion, and
a curvature of the second peripheral portion is equal to or smaller than the curvature of the center portion.

3. The microlens array substrate according to claim 1,
wherein the first microlens is formed of a material having a refractive index greater than a refractive index of the substrate so as to fill a recess provided on the substrate, and
the second microlens is formed of a material having a refractive index greater than the refractive index of the substrate so as to have a convex portion shape projected to a side opposite to the first microlens.

4. The microlens array substrate according to claim 3,
wherein a cross section shape of the second microlens is approximately symmetrical with respect to an apex of the center portion.

5. An electrooptical device comprising:
a first substrate including a switching element that is provided for each pixel, and a light shielding portion that includes an opening for each pixel and provided so as to be overlapped with the switching element in a plan view;
a second substrate that includes the microlens array substrate according to claim 1 and is disposed so as to face the first substrate; and
an electrooptical layer that is disposed between the first substrate and the second substrate,
wherein the first microlens and the second microlens are disposed so as to be overlapped with the opening for each pixel in a plan view.

6. An electrooptical device comprising:
a first substrate including a switching element that is provided for each pixel, and a light shielding portion that includes an opening for each pixel and provided so as to be overlapped with the switching element in a plan view;
a second substrate that includes the microlens array substrate according to claim 2 and is disposed so as to face the first substrate; and
an electrooptical layer that is disposed between the first substrate and the second substrate,
wherein the first microlens and the second microlens are disposed so as to be overlapped with the opening for each pixel in a plan view.

7. An electrooptical device comprising:
a first substrate including a switching element that is provided for each pixel, and a light shielding portion that includes an opening for each pixel and provided so as to be overlapped with the switching element in a plan view;
a second substrate that includes the microlens array substrate according to claim 3 and is disposed so as to face the first substrate; and
an electrooptical layer that is disposed between the first substrate and the second substrate,
wherein the first microlens and the second microlens are disposed so as to be overlapped with the opening for each pixel in a plan view.

8. An electrooptical device comprising:
a first substrate including a switching element that is provided for each pixel, and a light shielding portion that includes an opening for each pixel and provided so as to be overlapped with the switching element in a plan view;
a second substrate that includes the microlens array substrate according to claim 4 and is disposed so as to face the first substrate; and
an electrooptical layer that is disposed between the first substrate and the second substrate,
wherein the first microlens and the second microlens are disposed so as to be overlapped with the opening for each pixel in a plan view.

9. An electrooptical device comprising:
a first substrate that includes a light receiving element that is provided for each pixel, and a light shielding portion that includes an opening for each pixel; and
a second substrate that includes the microlens array substrate according to claim 1 and is disposed so as to face the first substrate,
wherein the first microlens, the second microlens, and the light receiving element are disposed so as to be overlapped with the opening for each pixel in a plan view.

10. An electrooptical device comprising:
a first substrate that includes a light receiving element that is provided for each pixel, and a light shielding portion that includes an opening for each pixel; and
a second substrate that includes the microlens array substrate according to claim 2 and is disposed so as to face the first substrate,
wherein the first microlens, the second microlens, and the light receiving element are disposed so as to be overlapped with the opening for each pixel in a plan view.

11. An electrooptical device comprising:
a first substrate that includes a light receiving element that is provided for each pixel, and a light shielding portion that includes an opening for each pixel; and
a second substrate that includes the microlens array substrate according to claim 3 and is disposed so as to face the first substrate,
wherein the first microlens, the second microlens, and the light receiving element are disposed so as to be overlapped with the opening for each pixel in a plan view.

12. An electrooptical device comprising:
a first substrate that includes a light receiving element that is provided for each pixel, and a light shielding portion that includes an opening for each pixel; and
a second substrate that includes the microlens array substrate according to claim 4 and is disposed so as to face the first substrate,
wherein the first microlens, the second microlens, and the light receiving element are disposed so as to be overlapped with the opening for each pixel in a plan view.

13. An electronic apparatus comprising:
the electrooptical device according to claim 5.

14. An electronic apparatus comprising:
the electrooptical device according to claim 9.

15. A manufacturing method of a microlens array substrate comprising:
forming a recess on a surface of a substrate;
forming a first lens layer with a material having a refractive index greater than a refractive index of the substrate so as to fill the recess of the substrate; and
forming a second lens layer having a convex portion configured with a curved surface disposed so as to be overlapped with the recess in a plan view, on the first lens layer with a material having a refractive index greater than the refractive index of the substrate,
wherein the convex portion includes a center portion and a first peripheral portion that is disposed on the outer side of the center portion, and
a curvature of the first peripheral portion is greater than a curvature of the center portion.

16. A manufacturing method of an electrooptical device comprising:
the manufacturing method of a microlens array substrate according to claim 15.
